(19) United States
(12) Patent Application Publication
(10) Pub. No.: US 2023/0192525 A1
(43) Pub. Date: Jun. 22, 2023

(54) COLD-FORMED COVER GLASS HAVING COMPOUND CURVATURE AND/OR MULTIPLE CURVATURES

(71) Applicant: CORNING INCORPORATED, CORNING, NY (US)

(72) Inventors: Khaled Layouni, Fontainebleau (FR); Kimberly Wilbert Smith, Hammondsport, NY (US); Christopher Lee Timmons, Big Flats, NY (US)

(21) Appl. No.: 18/011,285

(22) PCT Filed: Jun. 21, 2021
(86) PCT No.: PCT/US2021/038177

§ 371 Date: Dec. 19, 2022

Related U.S. Application Data
(60) Provisional application No. 63/044,419, filed on Jun. 26, 2020.
(60) Provisional application No. 63/064,608, filed on Aug. 12, 2020.
(60) Provisional application No. 63/082,523, filed on Sep. 24, 2020.

(51) Int. Cl. C03B 23/023

(52) U.S. Cl. CPC C03B 23/023

(57) ABSTRACT

Embodiments of this disclosure include a cold-formed cover glass substrate comprising a first end, a second end opposing the first end, opposing first and second major surfaces, a width, a length; a first axis and a second axis both extending along the width or both extending along the length; a first portion extending from the first axis to the first end that comprises a first radius of curvature, and a second portion extending from the first axis to the second axis. In one or more embodiments, the second portion includes a second radius of curvature that increases or decreases from the first axis to the second axis. In one or more embodiments, the cold-formed cover glass substrate comprises a third portion extending from the second axis to the second end, wherein the third portion differs from the first portion.

### CROSS-REFERENCE TO RELATED APPLICATIONS

This application claims the benefit of priority under 35 U.S.C. § 119 of U.S. Provisional Application Ser. No. 63/082,523 filed on Sep. 24, 2020 and U.S. Provisional Application Ser. No. 63/064,608 filed on Aug. 12, 2020 and U.S. Provisional Application Ser. No. 63/044,419 filed on Jun. 26, 2020, the content of which is relied upon and incorporated herein by reference in its entirety.

### BACKGROUND

The disclosure relates to cold-formed cover glass substrates having a compound curvature and/or multiple curvatures, and more particularly to cold-formed cover glass substrates including displays, touch panels or a combination thereof for use in automotive interior systems.

Automotive interiors systems can include various curved surfaces that incorporate displays and/or touch panels. The materials used to form cover materials for such curved surfaces are typically limited to polymers, which do not exhibit the durability and optical performance of glass. As such, curved glass articles are desirable, especially when used as covers for displays and/or touch panels and when exhibiting compound curvatures or multiple curvatures. In addition, automotive interiors systems typically need to rigorous headform impact test requirements. In some instances, the curved glass articles used in the automotive interiors systems should not break after being impacted in the headform impact test. Accordingly, there is a need for curved glass substrates with properties that result in automotive interior systems exhibiting curved shapes and improved headform impact performance, and automotive interior systems that incorporate such glass substrates.

### SUMMARY

A first aspect of this disclosure pertains to a cold-formed cover glass substrate comprising: a first end, a second end opposing the first end; a first major surface extending the first end to the second end, a second major surface opposing the first major surface, and a minor surface connecting the first major surface and the second major surface, a thickness defined as a distance between the first major surface and the second major surface, a width defined as a first dimension of one of the first or second major surfaces orthogonal to the thickness, a length defined as a second dimension of one of the first or second major surfaces orthogonal to both the thickness and the width; a first axis and a second axis that both extend along the width or the length, a first portion extending from the first axis to the first end, the first portion comprising a first radius of curvature in a range from about 20 mm to about 20,000 mm; a second portion extending from the first axis to the second axis, the second portion comprising a second radius of curvature that increases or decreases from the first axis to the second axis.

A second aspect of this disclosure pertains to a cold-formed cover glass substrate comprising: a first end, a second end opposing the first end; a first major surface extending the first end to the second end, a second major surface opposing the first major surface, and a minor surface connecting the first major surface and the second major surface, a thickness defined as a distance between the first major surface and the second major surface, a width defined as a first dimension of one of the first or second major surfaces orthogonal to the thickness, a length defined as a second dimension of one of the first or second major surfaces orthogonal to both the thickness and the width; a first axis and a second axis that both extend along the width or the length; a first portion extending from the first axis to the first end, the first portion comprising a first radius of curvature in a range from about 20 mm to about 20,000 mm; a second portion extending from the first axis to the second axis; and a third portion extending from the second axis to the second end, wherein the third portion comprises a third radius of curvature in a range from about 20 mm to about 20,000 mm, wherein the first portion and the third portion differ from one another.

A third aspect of this disclosure pertains to an automotive interior system comprising: a base; and the cold-formed cover glass substrate, according to any one of the embodiments of the first or second aspects of this disclosure, disposed on the base, and wherein, when an impactor having a mass of 6.8 kg impacts the first major surface at an impact velocity of 5.35 m/s to 6.69 m/s, the deceleration of the impactor is 120 g (g-force) or less.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a side view of a cover glass substrate according to one or more embodiments;

FIG. 2 is a top perspective view of the cover glass substrate of FIG. 1;

FIG. 3 is an enlarged view of the cover glass substrate of FIG. 2;

FIG. 4 illustrates a shape analysis of a cold-formed cover glass substrate of Example 1 along the width;

FIG. 5 illustrates a shape analysis of the cold-formed cover glass substrate shown in FIG. 4 along the length; and

FIG. 6 illustrates a shape analysis in terms of substrate Gaussian curvature of the cold-formed cover glass substrate shown in FIGS. 4-5.

### DETAILED DESCRIPTION

Reference will now be made in detail to the present preferred embodiment(s), an examples of which is/are illustrated in the accompanying drawings. Whenever possible, the same reference numerals will be used throughout the drawings to refer to the same or like parts.

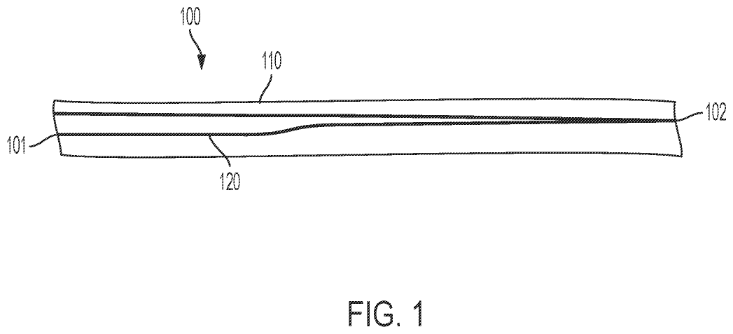

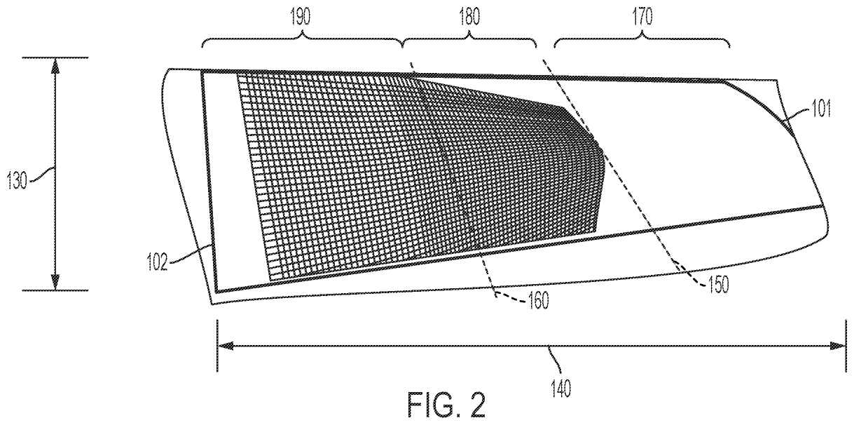

A first aspect of this disclosure pertains to a cold-formed cover glass substrate. As shown in FIG. 1, the cold-formed cover glass substrate 100 may include a first end 101, a second end 102 opposing the first end, a first major surface 110 extending from the first end to the second end, and a second major surface 120 opposing the first major surface. The cold-formed cover glass substrate includes a minor surface (not shown) connecting the first major surface and the second major surface, and a thickness defined as a distance between the first major surface and the second major surface. As shown in FIG. 2, the cold-formed cover glass substrate includes a width 130 defined as a first dimension of one of the first or second major surfaces orthogonal to the thickness, and a length 140 defined as a second dimension of one of the first or second major surfaces orthogonal to both the thickness and the width.

In one or more embodiments, the cold-formed cover glass substrate has a thickness that is about 2 mm or less, or 1.5 mm or less. In one or embodiments, the cold-formed cover glass substrate has a thickness that is greater than about 0.125 mm (e.g., about 0.13 mm or greater, about 0.15 mm or greater, about 0.2 mm or greater, about 0.25 mm or greater, about 0.3 mm or greater, about 0.35 mm or greater, about 0.4 mm or greater, about 0.45 mm or greater, about 0.5 mm or greater, about 0.55 mm or greater, about 0.6 mm or greater, about 0.65 mm or greater, about 0.7 mm or greater, about 0.75 mm or greater, or about 0.8 mm or greater. For example, the thickness may be in a range from about 0.01 mm to about 2 mm, 0.05 mm to about 2 mm, 0.1 mm to about 2 mm, from about 0.15 mm to about 2 mm, from about 0.2 mm to about 2 mm, from about 0.25 mm to about 2 mm, from about 0.3 mm to about 2 mm, from about 0.35 mm to about 2 mm, from about 0.4 mm to about 2 mm, from about 0.45 mm to about 2 mm, from about 0.5 mm to about 2 mm, from about 0.55 mm to about 2 mm, from about 0.6 mm to about 2 mm, from about 0.65 mm to about 2 mm, from about 0.7 mm to about 2 mm, from about 0.01 mm to about 1.5 mm, 0.05 mm to about 1.5 mm, 0.1 mm to about 1.5 mm, from about 0.15 mm to about 1.5 mm, from about 0.2 mm to about 1.5 mm, from about 0.25 mm to about 1.5 mm, from about 0.3 mm to about 1.5 mm, from about 0.35 mm to about 1.5 mm, from about 0.4 mm to about 1.5 mm, from about 0.45 mm to about 1.5 mm, from about 0.5 mm to about 1.5 mm, from about 0.55 mm to about 1.5 mm, from about 0.6 mm to about 1.5 mm, from about 0.65 mm to about 1.5 mm, from about 0.7 mm to about 1.5 mm, from about 0.01 mm to about 1.4 mm, from about 0.01 mm to about 1.3 mm, from about 0.01 mm to about 1.2 mm, from about 0.01 mm to about 1.1 mm, from about 0.01 mm to about 1.05 mm, from about 0.01 mm to about 1 mm, from about 0.01 mm to about 0.95 mm, from about 0.01 mm to about 0.9 mm, from about 0.01 mm to about 0.85 mm, from about 0.01 mm to about 0.8 mm, from about 0.01 mm to about 0.75 mm, from about 0.01 mm to about 0.7 mm, from about 0.01 mm to about 0.65 mm, from about 0.01 mm to about 0.6 mm, from about 0.01 mm to about 0.55 mm, from about 0.01 mm to about 0.5 mm, from about 0.01 mm to about 0.4 mm, from about 0.01 mm to about 0.3 mm, from about 0.01 mm to about 0.2 mm, from about 0.01 mm to about 0.1 mm, from about 0.04 mm to about 0.07 mm, from about 0.1 mm to about 1.4 mm, from about 0.1 mm to about 1.3 mm, from about 0.1 mm to about 1.2 mm, from about 0.1 mm to about 1.1 mm, from about 0.1 mm to about 1.05 mm, from about 0.1 mm to about 1 mm, from about 0.1 mm to about 0.95 mm, from about 0.1 mm to about 0.9 mm, from about 0.1 mm to about 0.85 mm, from about 0.1 mm to about 0.8 mm, from about 0.1 mm to about 0.75 mm, from about 0.1 mm to about 0.7 mm, from about 0.1 mm to about 0.65 mm, from about 0.1 mm to about 0.6 mm, from about 0.1 mm to about 0.55 mm, from about 0.1 mm to about 0.5 mm, from about 0.1 mm to about 0.4 mm, or from about 0.3 mm to about 0.7 mm.

In one or more embodiments, the thickness of the cold-formed cover glass substrate is substantially uniform. For example, the thickness of the cold-formed cover glass substrate does not vary by more than ±10%, 5% or 2% across the total surface area of the first major surface, the second major surface or both the first and second major surfaces. In one or more embodiments, the thickness is substantially constant (within ±1% of the average thickness) across 90%, 95% or 99% of the total surface area of the first major surface, the second major surface or both the first and second major surfaces.

In one or more embodiments, the cold-formed cover glass substrate has a width (W) in a range from about 5 cm to about 250 cm, from about 10 cm to about 250 cm, from about 15 cm to about 250 cm, from about 20 cm to about 250 cm, from about 25 cm to about 250 cm, from about 30 cm to about 250 cm, from about 35 cm to about 250 cm, from about 40 cm to about 250 cm, from about 45 cm to about 250 cm, from about 50 cm to about 250 cm, from about 55 cm to about 250 cm, from about 60 cm to about 250 cm, from about 65 cm to about 250 cm, from about 70 cm to about 250 cm, from about 75 cm to about 250 cm, from about 80 cm to about 250 cm, from about 85 cm to about 250 cm, from about 90 cm to about 250 cm, from about 95 cm to about 250 cm, from about 100 cm to about 250 cm, from about 110 cm to about 250 cm, from about 120 cm to about 250 cm, from about 130 cm to about 250 cm, from about 140 cm to about 250 cm, from about 150 cm to about 250 cm, from about 5 cm to about 240 cm, from about 5 cm to about 230 cm, from about 5 cm to about 220 cm, from about 5 cm to about 210 cm, from about 5 cm to about 200 cm, from about 5 cm to about 190 cm, from about 5 cm to about 180 cm, from about 5 cm to about 170 cm, from about 5 cm to about 160 cm, from about 5 cm to about 150 cm, from about 5 cm to about 140 cm, from about 5 cm to about 130 cm, from about 5 cm to about 120 cm, from about 5 cm to about 110 cm, from about 5 cm to about 110 cm, from about 5 cm to about 100 cm, from about 5 cm to about 90 cm, from about 5 cm to about 80 cm, or from about 5 cm to about 75 cm. As used herein, the term width refers to the maximum width along the length of the cold-formed cover glass substrate.

In one or more embodiments, the cold-formed cover glass substrate has a length (L) in a range from about 5 cm to about 250 cm, from about 10 cm to about 250 cm, from about 15 cm to about 250 cm, from about 20 cm to about 250 cm, from about 25 cm to about 250 cm, from about 30 cm to about 250 cm, from about 35 cm to about 250 cm, from about 40 cm to about 250 cm, from about 45 cm to about 250 cm, from about 50 cm to about 250 cm, from about 55 cm to about 250 cm, from about 60 cm to about 250 cm, from about 65 cm to about 250 cm, from about 70 cm to about 250 cm, from about 75 cm to about 250 cm, from about 80 cm to about 250 cm, from about 85 cm to about 250 cm, from about 90 cm to about 250 cm, from about 95 cm to about 250 cm, from about 100 cm to about 250 cm, from about 110 cm to about 250 cm, from about 120 cm to about 250 cm, from about 130 cm to about 250 cm, from about 140 cm to about 250 cm, from about 150 cm to about 250 cm, from about 5 cm to about 240 cm, from about 5 cm to about 230 cm, from about 5 cm to about 220 cm, from about 5 cm to about 210 cm, from about 5 cm to about 200 cm, from about 5 cm to about 190 cm, from about 5 cm to about 180 cm, from about 5 cm to about 170 cm, from about 5 cm to about 160 cm, from about 5 cm to about 150 cm, from about 5 cm to about 140 cm, from about 5 cm to about 130 cm, from about 5 cm to about 120 cm, from about 5 cm to about 110 cm, from about 5 cm to about 110 cm, from about 5 cm to about 100 cm, from about 5 cm to about 90 cm, from about 5 cm to about 80 cm, or from about 5 cm to about 75 cm. As used herein, the term length refers to the maximum length along the width of the cold-formed cover glass substrate.

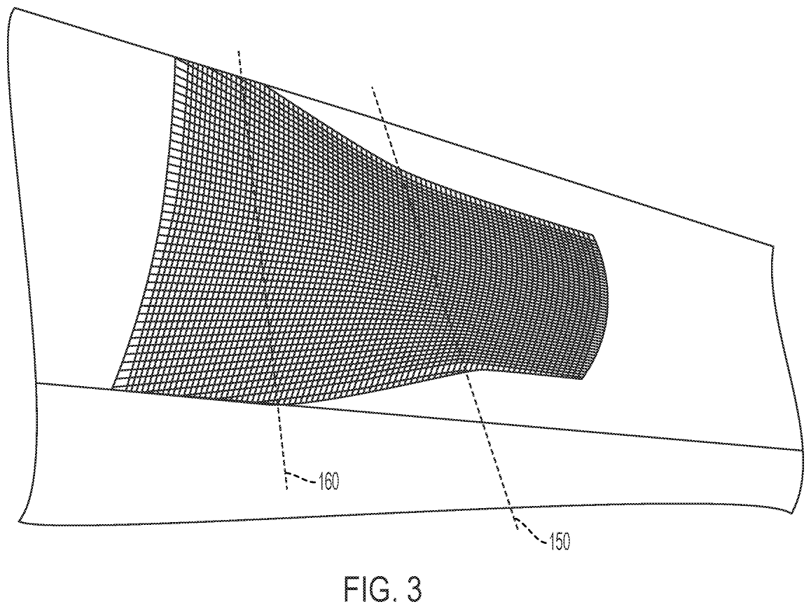

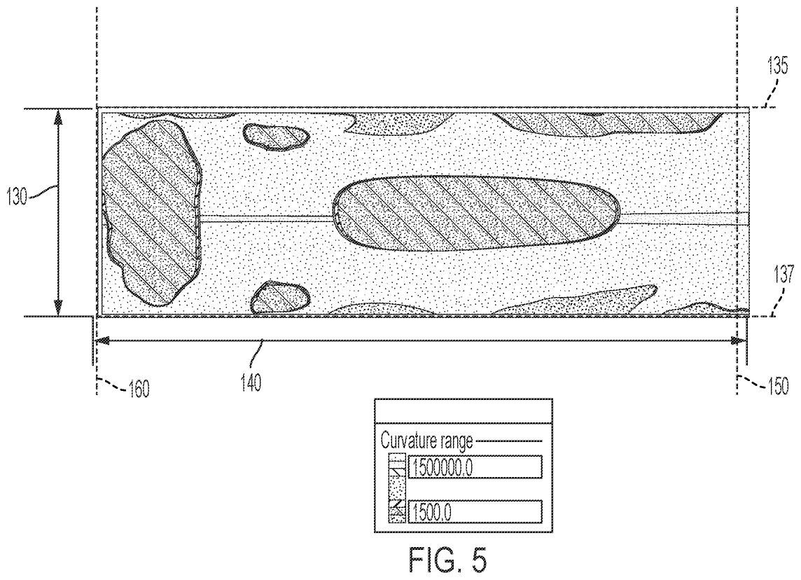

As shown in FIGS. 2 and 3, the cold-formed cover glass substrate includes a first axis 150 and a second axis 160 that both extend along the width (as shown in FIG. 2). In one or more embodiments, the first and second axes both extend along the length (not shown). The cold-formed cover glass substrate also includes a third axis 135 and a fourth axis 137, which are substantially perpendicular to the first and second axes, as shown in FIG. 5.

In one or more embodiments, the cold-formed cover glass substrate 100 includes a first portion 170 extending from the first end 101 to the first axis 150, and a second portion 180 extending form the first axis 150 to a second axis 160. As shown in FIG. 2, the first axis 150 and the second axis 160 are disposed between the first end 101 and second end 102. In one or additional or alternative embodiments, the first axis 150 is disposed between the first and second ends 101, 102, and the second axis is disposed at the second end (not shown). In such additional or alternative embodiments, the cold-formed cover glass substrate comprises only the first portion 170 and the second portion 180.

In one or more embodiments, the first portion comprises a first radius of curvature in a range from about 20 mm to about 20,000 mm. In one or more embodiments, first radius of curvature is from about 20 mm to about 19,000 mm, from about 20 mm to about 18,000 mm, from about 20 mm to about 16,000 mm, from about 20 mm to about 15,000 mm, from about 20 mm to about 14,000 mm, from about 20 mm to about 12,000 mm, from about 20 mm to about 10,000 mm, from about 20 mm to about 9,000 mm, from about 20 mm to about 8,000 mm, from about 20 mm to about 7,000 mm, from about 20 mm to about 6,000 mm, from about 20 mm to about 5,000 mm, from about 20 mm to about 4,000 mm, from about 20 mm to about 3,000 mm, from about 20 mm to about 2,000 mm, from about 20 mm to about 1,000 mm, from about 20 mm to about 900 mm, from about 20 mm to about 800 mm, from about 20 mm to about 1700 mm, from about 20 mm to about 750 mm, from about 20 mm to about 600 mm, from about 20 mm to about 500 mm, from about 20 mm to about 400 mm, from about 20 mm to about 300 mm, from about 20 mm to about 250 mm, from about 20 mm to about 200 mm, from about 20 mm to about 100 mm, from about 20 mm to about 50 mm, from about 50 mm to about 20,000 mm, from about 75 mm to about 20,000 mm, from about 100 mm to about 20,000 mm, from about 200 mm to about 20,000 mm, from about 300 mm to about 20,000 mm, from about 400 mm to about 20,000 mm, from about 500 mm to about 20,000 mm, from about 600 mm to about 20,000 mm, from about 700 mm to about 20,000 mm, from about 800 mm to about 20,000 mm, from about 900 mm to about 20,000 mm, from about 1,000 mm to about 20,000 mm, from about 1,100 mm to about 20,000 mm, from about 1,200 mm to about 20,000 mm, from about 1,300 mm to about 20,000 mm, from about 1,400 mm to about 20,000 mm, from about 1,500 mm to about 20,000 mm, from about 1,600 mm to about 20,000 mm, from about 1,700 mm to about 20,000 mm, from about 1,800 mm to about 20,000 mm, from about 1,900 mm to about 20,000 mm, from about 2,000 mm to about 20,000 mm, from about 2,100 mm to about 20,000 mm, from about 2,200 mm to about 20,000 mm, from about 2,300 mm to about 20,000 mm, from about 2,400 mm to about 20,000 mm, from about 2,500 mm to about 20,000 mm, from about 3,000 mm to about 20,000 mm, from about 3,500 mm to about 20,000 mm, from about 4,000 mm to about 20,000 mm, from about 5,000 mm to about 20,000 mm, from about 7,500 mm to about 20,000 mm, from about 20 mm to about 1,000 mm, from about 200 mm to about 1,000 mm, or from about 400 mm to about 1,000 mm.

In one or more embodiments, the cold-formed cover glass substrate is curved by cold-forming. As used herein, the terms “cold-forming” and cold-formed” means a curvature that is imparted to the cover glass substrate at a cold-forming temperature which is less than the softening point of the glass. Often, the cold-forming temperature is room temperature. The term “cold-formable” refers to the capability of a cover glass substrate to be cold-formed. In one or more embodiments the cold-formed cover glass substrate may optionally be strengthened. In more embodiments, a feature of a cold-formed cover glass substrate is asymmetric surface compressive stress between the first major surface 101 and the second major surface 102. In one or more embodiments, prior to the cold-forming process or being cold-formed, the respective compressive stresses in the first major surface 101 and the second major surface 102 of the cover glass substrate are substantially equal. In one or more embodiments in which the cover glass substrate is unstrengthened, the first major surface 101 and the second major surface 102 exhibit no appreciable compressive stress (CS), prior to cold-forming. In one or more embodiments in which the cover glass substrate is strengthened (as described herein), the first major surface 101 and the second major surface 102 exhibit substantially equal compressive stress with respect to one another, prior to cold-forming. In one or more embodiments, after cold-forming, the CS on the surface having a concave shape after cold-forming increases, while the CS on the surface having a convex shape after cold-forming decreases. In other words, the CS on the concave surface is greater after cold-forming than before cold-forming. Without being bound by theory, the cold-forming process increases the CS of the cover glass substrate being shaped to compensate for tensile stresses imparted during cold-forming. In one or more embodiments, the cold-forming process causes the concave surface to experience compressive stresses, while the surface forming a convex shape after cold-forming experiences tensile stresses. The tensile stress experienced by the convex surface following cold-forming results in a net decrease in surface compressive stress, such that the compressive stress in convex surface of a strengthened cover glass substrate following cold-forming is less than the compressive stress on the same surface when the cover glass substrate is flat. Cold-formed cover glass substrates differ from hot formed glass substrates which are permanently curved and the first major surface and the second major surface have the same CS as one another.

In one or more embodiments, the second portion 180 comprises a shape that forms a transition zone between the first axis and the second axis. In one or more embodiment, the second portion includes a second radius of curvature that increases or decreases from the first axis to the second axis. In the embodiments shown in FIGS. 1-6, the radius of curvature of the second portion 180 increases from the first axis 150 (i.e., from the first portion 170) to the second axis 160. The changes in radius of curvature are illustrated by the grid lines in FIGS. 2-3. In one or more embodiments, the increase or decrease in the second radius of curvature is non-linear. In one or more embodiments, the second radius of curvature increases and decreases from the first axis 150 to the second axis 160.

In one or more embodiments the increase or decrease in the second radius of curvature of the second portion is substantially linear for at least a portion of the second portion. Without being bound by theory, the shape and/or length or width dimension of the second portion is based on the natural lowest stress state of the cover glass substrate. In some embodiments, the natural lowest stress state is along the second portion. In one or more embodiments, the cold-formed cover glass substrate exhibits or comprises a surface tensile stress measured on one of the first or second major surface having a convex shape that decreases from the first axis to the second axis. In such embodiments, the second radius of curvature increases from the first axis to the second axis. In some embodiments, one or more of the second radius of curvature may be greater than 30,000 mm or may approach infinity at or near the second axis (i.e., such that cold-formed cover glass substrate is substantially flat at or near the second axis). In one or more embodiments, the surface tensile stress on one of the first or second major surface having a convex shape measured from the first axis to the second axis decreases by a magnitude of about 200 MPa, about 150 MPa, about 100 MPa, about 90 MPa, about 80 MPa, about 70 MPa, about 60 MPa, about 50 MPa, about 40 MPa, about 30 MPa, about 20 MPa or about 10 MPa. In one or more specific embodiments, where the radius of curvature at or near the second axis is greater than 30,000 mm or approaches infinity, the surface stress on the cold-formed cover glass substrate at the first axis may be in a range from about 10 MPa to about 200 MPa and the surface stress at the second axis may be less than about 10 MPa, less than about 5 MPa, or about 0 MPa. Accordingly, in one or more embodiments, the surface stress may decrease from a value at the first axis to a value at the second axis which ranges from about 200 MPa to about 0 MPa, from about 190 MPa to about 0 MPa, from about 180 MPa to about 0 MPa, from about 170 MPa to about 0 MPa, from about 160 MPa to about 0 MPa, from about 150 MPa to about 0 MPa, from about 140 MPa to about 0 MPa, from about 130 MPa to about 0 MPa, from about 120 MPa to about 0 MPa, from about 110 MPa to about 0 MPa, from about 100 MPa to about 0 MPa, from about 90 MPa to about 0 MPa, from about 80 MPa to about 0 MPa, from about 70 MPa to about 0 MPa, from about 60 MPa to about 0 MPa, from about 50 MPa to about 0 MPa, from about 40 MPa to about 0 MPa, from about 30 MPa to about 0 MPa, from about 20 MPa to about 0 MPa, or from about 10 MPa to about 0 MPa. In one or more embodiments, the tensile stress measured on the minor surface at the second end 102 of the cold-formed cover glass substrate is about 10 MPa or less, about 8 MPa or less, about 6 MPa or less, about 5 MPa or less, about 4 MPa or less, about 2 MPa or less or about 1 MPa or less. In such embodiments, the radius of curvature at the second end greater than about 30,000 mm and may approach infinity. As used herein, the stress on the surface of the cold-formed cover glass substrate is calculated using Equation (1).

stress at surface=E*t/2R, wherein E is Young's modulus, t is the thickness of the cold-formed cover glass substrate, and R is the radius of curvature. Equation (1):

In one or more embodiments, the second radius of curvature is in a range from the first radius of curvature to infinity. In one or more specific embodiments, the second radius of curvature is in a range from the first radius of curvature to about 30,000 mm, from the first radius of curvature to about 40,000 mm, or from the first radius of curvature to about 50,000 mm.

In one or more embodiments, the distance between the first axis and the second axis is about 100 μm or less. In one or more embodiments, the distance between the first axis and the second axis is in a range from about 5 μm to about 100 μm, from about 7.5 μm to about 100 μm, from about 10 μm to about 100 μm, from about 15 μm to about 100 μm, from about 20 μm to about 100 μm, from about 25 μm to about 100 μm, from about 30 μm to about 100 μm, from about 35 μm to about 100 μm, from about 40 μm to about 100 μm, from about 45 μm to about 100 μm, from about 50 μm to about 100 μm, from about 55 μm to about 100 μm, from about 60 μm to about 100 μm, from about 65 μm to about 100 μm, from about 70 μm to about 100 μm, from about 75 μm to about 100 μm, from about 5 μm to about 95 μm, from about 5 μm to about 90 μm, from about 5 μm to about 85 μm, from about 5 μm to about 80 μm, from about 5 μm to about 75 μm, from about 5 μm to about 70 μm, from about 5 μm to about 65 μm, from about 5 μm to about 60 μm, from about 5 μm to about 55 μm, from about 5 μm to about 50 μm, from about 5 μm to about 45 μm, from about 5 μm to about 40 μm, from about 5 μm to about 35 μm, from about 5 μm to about 30 μm, from about 5 μm to about 25 μm, from about 5 μm to about 20 μm, or from about 5 μm to about 15 μm. In one or more embodiments, the distance between the first axis and the second axis is about 10 micrometers (μm) or less.

In one or more embodiments, the cold-formed cover glass substrate includes a third portion 190, as shown in FIG. 2. In one or more embodiments, the third portion 190 extends from the second axis 160 to the second end 102. In one or more embodiments, the first portion and the third portion differ from one another. In one or more embodiments, the third portion 190 comprises a third radius of curvature that differs from the first radius of curvature of the first portion 170. In one or more embodiments, the first portion 170 comprises a concave curvature and the third portion 190 comprises a convex curvature. In one or more embodiments, wherein the first portion 170 comprises a convex curvature and the third portion 190 comprises a concave curvature. In one or more embodiments, the first portion 170 and the third portion 190 comprise a convex curvature. In one or more embodiments, the first portion 170 and the third portion 190 comprise a concave curvature. In one or more embodiments, the first portion 170 comprises a compound curvature and the third portion 180 comprises a cylindrical curvature. In one or more embodiments, the third portion 180 comprises a compound curvature and the first portion 170 comprises a cylindrical curvature.

In one or more specific embodiments, the first radius of curvature and the third radius of curvature differ from one another in magnitude (as shown by the grid lines in FIG. 3) or in consistency along the width or length of the first portion and third portion, respectively. In one or more embodiments, the first portion comprises a concave shape or a convex shape and the third portion comprises the other of a concave shape or a convex shape. In one or more embodiments, the first portion and the third portion are oriented along two bend axes that differ from one another. In one or more embodiments, the two bend axes are perpendicular, or intersect.

In one or more embodiments, the third radius of curvature is in a range from about 20 mm to infinity. In one or more specific embodiments, the third radius of curvature is in a range from about 50 mm to infinity, from about 100 mm to infinity, from about 150 mm to infinity, from about 200 mm to infinity, from about 250 mm to infinity, from about 300 mm to infinity, from about 350 mm to infinity, from about 400 mm to infinity, from about 450 mm to infinity, from about 500 mm to infinity, from about 600 mm to infinity, from about 700 mm to infinity, from about 800 mm to infinity, from about 900 mm to infinity, from about 1,000 mm to infinity, from about 1,200 mm to infinity, from about 1,400 mm to infinity, from about 1,500 mm to infinity, from about 1,600 mm to infinity, from about 1,700 mm to infinity, from about 1,800 mm to infinity, from about 1,900 mm to infinity, from about 2,000 mm to infinity, from about 2,500 mm to infinity, from about 5,000 mm to infinity, from about 7,500 mm to infinity, from about 10,000 mm to infinity, from about 15,000 mm to infinity, from 25,000 mm to infinity, from 50,000 mm to infinity, from 100,000 mm to infinity, from 500,000 mm to infinity, or from 1,000 m to infinity. In one or more embodiments, the third radius of curvature is from about 20 mm to about 30,000 mm, from about 20 mm to about 25,000 mm, from about 20 mm to about 20,000 mm, from about 20 mm to about 18,000 mm, from about 20 mm to about 16,000 mm, from about 20 mm to about 15,000 mm, from about 20 mm to about 14,000 mm, from about 20 mm to about 12,000 mm, from about 20 mm to about 10,000 mm, from about 20 mm to about 9,000 mm, from about 20 mm to about 8,000 mm, from about 20 mm to about 7,000 mm, from about 20 mm to about 6,000 mm, from about 20 mm to about 5,000 mm, from about 20 mm to about 4,000 mm, from about 20 mm to about 3,000 mm, from about 20 mm to about 2,000 mm, from about 20 mm to about 1,000 mm, from about 20 mm to about 750 mm, from about 20 mm to about 500 mm from about 20 mm to about 250 mm, from about 50 mm to about 20,000 mm, from about 75 mm to about 20,000 mm, from about 100 mm to about 20,000 mm, from about 200 mm to about 20,000 mm, from about 300 mm to about 20,000 mm, from about 400 mm to about 20,000 mm, from about 500 mm to about 20,000 mm, from about 600 mm to about 20,000 mm, from about 700 mm to about 20,000 mm, from about 800 mm to about 20,000 mm, from about 900 mm to about 20,000 mm, from about 1,000 mm to about 20,000 mm, from about 1,100 mm to about 20,000 mm, from about 1,200 mm to about 20,000 mm, from about 1,300 mm to about 20,000 mm, from about 1,400 mm to about 20,000 mm, from about 1,500 mm to about 20,000 mm, from about 1,600 mm to about 20,000 mm, from about 1,700 mm to about 20,000 mm, from about 1,800 mm to about 20,000 mm, from about 1,900 mm to about 20,000 mm, from about 2,000 mm to about 20,000 mm, from about 2,100 mm to about 20,000 mm, from about 2,200 mm to about 20,000 mm, from about 2,300 mm to about 20,000 mm, from about 2,400 mm to about 20,000 mm, from about 2,500 mm to about 20,000 mm, from about 3,000 mm to about 20,000 mm, from about 3,500 mm to about 20,000 mm, from about 4,000 mm to about 20,000 mm, from about 5,000 mm to about 20,000 mm, from about 7,500 mm to about 20,000 mm, from about 20 mm to about 1,000 mm, from about 200 mm to about 1,000 mm, or from about 400 mm to about 1,000 mm.

In one or more embodiments, the first portion, the second portion, the third portion or any two or more of the first portion, the second portion and the third portion comprise a compound curvature. In one or more embodiments, compound curvature is defined as having a non-zero Gaussian curvature. As used herein, the term Gaussian curvature (K) refers to the Gaussian curvature of a surface at a point is the product of principal curvatures, R1 and R2, at the given point (Equation(2)). R1 is the radius of curvature along one of the width and length, and R2 is the radius of curvature along the other of the width and the length.

K=1/(R1*R2) Equation (2)

A substrate having a single curvature along one direction, one of the principal curvatures is infinity, which results in a Gaussian curvature (K) of zero. A substrate having a curvature along more than one direction, the principal curvatures R1 and R2 are not infinity, resulting in a non-zero Gaussian curvature. Typically Gaussian curvature may be expressed as a positive value or negative value indicating a convex or a concave shape. As used herein, Gaussian curvature is expressed as an absolute value that is applicable to either a convex or concave shape.

In one or more embodiments, the first portion, the second portion, the third portion or any two or more of the first portion, the second portion and the third portion comprise a substrate Gaussian curvature that is non-zero up to about 5×10⁻⁶ or non-zero up to about 3×10⁻⁶. In one or more embodiments, the first portion, the second portion, the third portion or any two or more of the first portion, the second portion and the third portion comprise a substrate Gaussian curvature that is in a range from about 0.1×10⁻⁶ to about 5×10⁻⁶, from about 0.1×10⁻⁶ to about 4.5×10⁻⁶, from about 0.1×10⁻⁶ to about 4×10⁻⁶, from about 0.1×10⁻⁶ to about 3.5×10⁻⁶, from about 0.1×10⁻⁶ to about 3×10⁻⁶, from about 0.1×10⁻⁶ to about 2.5×10⁻⁶, from about 0.1×10⁻⁶ to about 2×10⁻⁶, from about 0.1×10⁻⁶ to about 1.8×10⁻⁶, from about 0.1×10⁻⁶ to about 1.75×10⁻⁶, from about 0.1×10⁻⁶ to about 1.7×10⁻⁶, from about 0.1×10⁻⁶ to about 1.6×10⁻⁶, from about 0.1×10⁻⁶ to about 1.5×10⁻⁶, from about 0.1×10⁻⁶ to about 1.4×10⁻⁶, from about 0.1×10⁻⁶ to about 1.3×10⁻⁶, from about 0.1×10⁻⁶ to about 1.25×10⁻⁶, from about 0.1×10⁻⁶ to about 1.2×10⁻⁶, from about 0.1×10⁻⁶ to about 1.1×10⁻⁶, from about 0.1×10⁻⁶ to about 1×10⁻⁶, from about 0.1×10⁻⁶ to about 0.9×10⁻⁶, from about 0.1×10⁻⁶ to about 0.8×10⁻⁶, from about 0.1×10⁻⁶ to about 0.75×10⁻⁶, from about 0.1×10⁻⁶ to about 0.7×10⁻⁶, from about 0.1×10⁻⁶ to about 0.6×10⁻⁶, from about 0.1×10⁻⁶ to about 0.5×10⁻⁶, from about 0.1×10⁻⁶ to about 0.4×10⁻⁶, from about 0.1×10⁻⁶ to about 0.3×10⁻⁶, from about 0.1×10⁻⁶ to about 0.2×10⁻⁶, from about 0.2×10⁻⁶ to about 5×10⁻⁶, from about 0.25×10⁻⁶ to about 5×10⁻⁶, from about 0.3×10⁻⁶ to about 5×10⁻⁶, from about 0.4×10⁻⁶ to about 5×10⁻⁶, from about 0.5×10⁻⁶ to about 5×10⁻⁶, from about 0.6×10⁻⁶ to about 5×10⁻⁶, from about 0.7×10⁻⁶ to about 5×10⁻⁶, from about 0.75×10⁻⁶ to about 5×10⁻⁶, from about 0.8×10⁻⁶ to about 5×10⁻⁶, from about 0.9×10⁻⁶ to about 5×10⁻⁶, from about 1×10⁻⁶ to about 5×10⁻⁶, from about 1.5×10⁻⁶ to about 5×10⁻⁶, from about 2×10⁻⁶ to about 5×10⁻⁶, from about 2.5×10⁻⁶ to about 5×10⁻⁶, from about 3×10⁻⁶ to about 5×10⁻⁶, from about 3.5×10⁻⁶ to about 5×10⁻⁶, from about 4×10⁻⁶ to about 5×10⁻⁶, from about 2×10⁻⁶ to about 4×10⁻⁶, or from about 2.5×10⁻⁶ to about 3.5×10⁻⁶.

In one or more embodiments, at least 5%, at least 10%, at least 20% or at least 30% of the surface area of the first or second major surface of the first portion, the second portion, the third portion or any two or more of the first portion, the second portion and the third portion, comprise a non-zero substrate Gaussian curvature.

In one or more specific embodiments, the second portion is curved, and comprises the substrate Gaussian curvature described herein.

In one or more embodiments, where the cold-formed cover glass substrate further comprises a support structure, the support structure may include a support surface that is attached to the first major surface of the cold-formed cover glass substrate at one or more of the first portion, the second portion and the third portion and forms an interface with first major surface of the first portion, the second portion and the third portion. In such embodiments, the first major surface of the cold-formed cover glass substrate comprises the substrate Gaussian curvature and the support surface comprises a support Gaussian curvature that is within 10% of the substrate Gaussian curvature of first major surface. For example, the support surface comprises a support Gaussian curvature that is within 9%, 8%, 7%, 6%, 5%, 3%, 2% or 1% of the substrate Gaussian curvature of first major surface.

In one or more embodiments, the third portion comprises a second glass substrate attached to one or both of the first and second major surfaces. In such embodiments, the third portion may be described as a laminate with an intervening adhesive or polymeric layer between the third portion and the second glass substrate. In one or more embodiments, the adhesive or polymeric layer comprises an optically clear adhesive (i.e., an adhesive having a transmission of greater than 90%, 95% or 99% along the visible spectrum).

In one or more embodiments, the either one of or both the first major surface 101 and the second major surface 102 of the cold-formed cover glass substrate includes a surface treatment. The surface treatment may cover at least a portion of the first major surface 101 and the second major surface 102. Exemplary surface treatments include an easy-to-clean surface, an anti-glare surface, an anti-reflective surface, a haptic surface, and a decorative surface. In one or more embodiments, the at least a portion of the first major surface 101 and/or the second major surface 102 may include any one, any two or all three of an anti-glare surface, an anti-reflective surface, a haptic surface, and a decorative surface. For example, first major surface 101 may include an anti-glare surface and the second major surface 102 may include an anti-reflective surface. In another example, the first major surface 101 includes an anti-reflective surface and the second major 102 includes an anti-glare surface. In yet another example, the first major surface 101 comprises either one of or both the anti-glare surface and the anti-reflective surface, and the second major surface 102 includes the decorative surface.

The anti-glare surface may be formed using an etching process and may exhibit a transmission haze 20% or less (e.g., about 15% or less, about 10% or less, 5% or less). In one or more the anti-glare surface may have a distinctiveness of image (DOI) of about 80 or less. As used herein, the terms “transmission haze” and “haze” refer to the percentage of transmitted light scattered outside an angular cone of about ±2.5° in accordance with ASTM procedure D1003. For an optically smooth surface, transmission haze is generally near zero. As used herein, the term “distinctness of image” is defined by method A of ASTM procedure D5767 (ASTM 5767), entitled “Standard Test Methods for Instrumental Measurements of Distinctness-of-Image Gloss of Coating Surfaces,” the contents of which are incorporated herein by reference in their entirety. In accordance with method A of ASTM 5767, substrate reflectance factor measurements are made on the anti-glare surface at the specular viewing angle and at an angle slightly off the specular viewing angle. The values obtained from these measurements are combined to provide a DOI value. In particular, DOI is calculated according to the Equation (3).

$$DOI = [ 1 - \frac{R o s}{R s} ] \times 100 , \qquad Equation ( 3 )$$

where Ros is the relative reflection intensity average between 0.2° and 0.4 away from the specular reflection direction, and Rs is the relative reflection intensity average in the specular direction (between +0.05° and −0.05°, centered around the specular reflection direction). If the input light source angle is +20° from the sample surface normal (as it is throughout this disclosure), and the surface normal to the sample is taken as 0°, then the measurement of specular reflected light Rs is taken as an average in the range of about −19.95° to −20.05°, and Ros is taken as the average reflected intensity in the range of about −20.2° to −20.4° (or from −19.6° to −19.8°, or an average of both of these two ranges). As used herein, DOI values should be directly interpreted as specifying a target ratio of Ros/Rs as defined herein. In some embodiments, the anti-glare surface has a reflected scattering profile such that >95% of the reflected optical power is contained within a cone of +/−10°, where the cone is centered around the specular reflection direction for any input angle.

The anti-glare surface may have a surface roughness (Ra) from about 10 nm to about 70 nm (e.g., from about 10 nm to about 68 nm, from about 10 nm to about 66 nm, from about 10 nm to about 65 nm, from about 10 nm to about 64 nm, from about 10 nm to about 62 nm, from about 10 nm to about 60 nm, from about 10 nm to about 55 nm, from about 10 nm to about 50 nm, from about 10 nm to about 45 nm, from about 10 nm to about 40 nm, from about 12 nm to about 70 nm, from about 14 nm to about 70 nm, from about 15 nm to about 70 nm, from about 16 nm to about 70 nm, from about 18 nm to about 70 nm, from about 20 nm to about 70 nm, from about 22 nm to about 70 nm, from about 24 nm to about 70 nm, from about 25 nm to about 70 nm, from about 26 nm to about 70 nm, from about 28 nm to about 70 nm, or from about 30 nm to about 70 nm). The anti-glare surface may include a textured surface with plurality of concave features having an opening facing outwardly from the surface. The opening may have an average cross-sectional dimension of about 30 micrometers or less (e.g., from about 2 micrometers to about 30 micrometers, from about 4 micrometers to about 30 micrometers, from about 5 micrometers to about 30 micrometers, from about 6 micrometers to about 30 micrometers, from about 8 micrometers to about 30 micrometers, from about 10 micrometers to about 30 micrometers, from about 12 micrometers to about 30 micrometers, from about 15 micrometers to about 30 micrometers, from about 2 micrometers to about 25 micrometers, from about 2 micrometers to about 20 micrometers, from about 2 micrometers to about 18 micrometers, from about 2 micrometers to about 16 micrometers, from about 2 micrometers to about 15 micrometers, from about 2 micrometers to about 14 micrometers, from about 2 micrometers to about 12 micrometers, or from about 8 micrometers to about 15 micrometers). In one or more embodiments, the anti-glare surface exhibits low sparkle (in terms of low pixel power deviation reference or PPDr) such as PPDr of about 6% or less, 4% or less, 3% or less, 2% or less, or about 1% or less. As used herein, the terms “pixel power deviation referenced” and “PPDr” refer to the quantitative measurement for display sparkle. Unless otherwise specified, PPDr is measured using a display arrangement that includes an edge-lit liquid crystal display screen (twisted nematic liquid crystal display) having a native sub-pixel pitch of 60 μm×180 μm and a sub-pixel opening window size of about 44 μm×about 142 The front surface of the liquid crystal display screen had a glossy, anti-reflection type linear polarizer film. To determine PPDr of a display system or an anti-glare surface that forms a portion of a display system, a screen is placed in the focal region of an “eye-simulator” camera, which approximates the parameters of the eye of a human observer. As such, the camera system includes an aperture (or “pupil aperture”) that is inserted into the optical path to adjust the collection angle of light, and thus approximate the aperture of the pupil of the human eye. In the PPDr measurements described herein, the iris diaphragm subtends an angle of 18 milliradians.

The anti-reflective surface may be formed by a multi-layer coating stack formed from alternating layers of a high refractive index material and a low refractive index material. Such coatings stacks may include 6 layers or more. In one or more embodiment, the anti-reflective surface may exhibit a single-side average light reflectance of about 2% or less (e.g., about 1.5% or less, about 1% or less, about 0.75% or less, about 0.5% or less, or about 0.25% or less) over the optical wavelength regime in the range from about 400 nm to about 800 nm. The average reflectance is measured at an incident illumination angle greater than about 0 degrees to less than about 10 degrees.

The decorative surface may include any aesthetic design formed from a pigment (e.g., ink, paint and the like) and can include a wood-grain design, a brushed metal design, a graphic design, a portrait, or a logo. In one or more embodiments, the decorative surface exhibits a deadfront effect in which the decorative surface disguises or masks the underlying display from a viewer when the display is turned off but permits the display to be viewed when the display is turned on. The decorative surface may be printed onto the glass substrate. In one or more embodiments, the anti-glare surface includes an etched surface. In one or more embodiments, the anti-reflective surface includes a multi-layer coating. In one or more embodiments, the easy-to-clean surface includes an oleophobic coating that imparts anti-fingerprint properties. In one or more embodiments, the haptic surface includes a raised or recessed surface formed from depositing a polymer or glass material on the surface to provide a user with tactile feedback when touched.

In one or more embodiments, the surface treatment (i.e., the easy-to-clean surface, the anti-glare surface, the anti-reflective surface, the haptic surface and/or the decorative surface) is disposed on at least a portion of the periphery of the first and/or second major surface and the interior portion of such surface is substantially free of the surface treatment.

In one or more embodiments, the cold-formed cover glass substrate is substantially free of an anti-splinter film.

In one or more embodiments, the cover glass substrate includes a glass or glass ceramic. Examples of suitable glass composition families used to form the cover glass substrate include soda lime glass, alkali aluminosilicate glass, alkali containing borosilicate glass and alkali aluminoborosilicate glass. In one or more alternative embodiments, the cover substrate may include crystalline substrates such as glass ceramics or may include a single crystal structure, such as sapphire. In one or more specific embodiments, the cover glass substrate includes an amorphous base (e.g., glass) and a crystalline cladding (e.g., sapphire layer, a polycrystalline alumina layer and/or or a spinel (MgAl₂O₄) layer).

In one or more embodiment the cover glass substrate is strengthened. In one or more embodiments, the cover glass substrate has a compressive stress (CS) region that extends from one or both major surfaces 110, 120, to a first depth of compression (DOC). The CS region includes a maximum CS magnitude (CSₘₐₓ). The cover glass substrate has a CT region disposed in the central region that extends from the DOC to an opposing CS region. The CT region defines a maximum CT magnitude (CTₘₐₓ). The CS region and the CT region define a stress profile that extends along the thickness of the cover glass substrate.

In one or more embodiments, the cover glass substrate may be strengthened mechanically by utilizing a mismatch of the coefficient of thermal expansion between portions of the article to create a compressive stress region and a central region exhibiting a tensile stress. In some embodiments, the cover glass may be strengthened thermally by heating the glass to a temperature above the glass transition point and then rapidly quenching.

In one or more embodiments, the cover glass substrate may be chemically strengthening by ion exchange. In the ion exchange process, ions at or near the surface of the cover glass substrate are replaced by—or exchanged with—larger ions having the same valence or oxidation state. In those embodiments in which the cover glass substrate article comprises an alkali aluminosilicate glass, ions in the surface layer of the article and the larger ions are monovalent alkali metal cations, such as Li+, Na+, K+, Rb+, and Cs+. Alternatively, monovalent cations in the surface layer may be replaced with monovalent cations other than alkali metal cations, such as Ag+ or the like. In such embodiments, the monovalent ions (or cations) exchanged into the cover glass substrate generate a stress.

Ion exchange processes are typically carried out by immersing a cover glass substrate in one or more molten salt baths containing the larger ions to be exchanged with the smaller ions in the cover glass substrate. It should be noted that aqueous salt baths may also be utilized. In addition, the composition of the bath(s) may include more than one type of larger ion (e.g., Na+ and K+) or a single larger ion. It will be appreciated by those skilled in the art that parameters for the ion exchange process, including, but not limited to, bath composition and temperature, immersion time, the number of immersions of the cover glass substrate in a salt bath (or baths), use of multiple salt baths, additional steps such as annealing, washing, and the like, are generally determined by the composition of the cover glass substrate (including the structure of the article and any crystalline phases present) and the desired CS, DOC and CT values of the cover glass substrate that results from strengthening. Exemplary molten bath composition may include nitrates, sulfates, and chlorides of the larger alkali metal ion. Typical nitrates include KNO₃, NaNO₃, LiNO₃, NaSO₄ and combinations thereof. The temperature of the molten salt bath typically is in a range from about 380° C. up to about 450° C., while immersion times range from about 15 minutes up to about 100 hours depending on cover glass substrate thickness, bath temperature and glass (or monovalent ion) diffusivity. However, temperatures and immersion times different from those described above may also be used.

In one or more embodiments, the cover glass substrate may be immersed in a molten salt bath of 100% NaNO₃, 100% KNO₃, or a combination of NaNO₃ and KNO₃ having a temperature from about 370° C. to about 480° C. In some embodiments, the cover glass substrate may be immersed in a molten mixed salt bath including from about 1% to about 99% KNO₃ and from about 1% to about 99% NaNO₃. In one or more embodiments, the cover glass substrate may be immersed in a second bath, after immersion in a first bath. The first and second baths may have different compositions and/or temperatures from one another. The immersion times in the first and second baths may vary. For example, immersion in the first bath may be longer than the immersion in the second bath.

In one or more embodiments, the cover glass substrate may be immersed in a molten, mixed salt bath including NaNO₃ and KNO₃ (e.g., 49%/51%, 50%/50%, 51%/49%) having a temperature less than about 420° C. (e.g., about 400° C. or about 380° C.). for less than about 5 hours, or even about 4 hours or less. In one or more embodiments, the cover glass is immersed in a first mixed molten salt bath (e.g., 75% KNO₃/25% NaNO₃) having a temperature of 430° C. for 8 hours, and then immersed in a second pure molten salt bath of KNO3 having a lower temperature than the first mixed molten salt bath for a shorter duration (e.g., about 4 hours). In one or more embodiments, the cover glass substrate may be chemically strengthened by immersing in a first bath having a composition of 75% KNO₃ and 25% NaNO₃ and bath temperature of 430° C. for 8 hours, followed by immersing in a second bath having a composition of 100% KNO₃ and bath temperature of 390° C. for 4 hours.

Ion exchange conditions can be tailored to provide a “spike” or to increase the slope of the stress profile at or near the surface of the resulting cover glass substrate. The spike may result in a greater surface CS value. This spike can be achieved by single bath or multiple baths, with the bath(s) having a single composition or mixed composition, due to the unique properties of the glass or glass ceramic compositions used in the cover glass substrate described herein.

In one or more embodiments, where more than one monovalent ion is exchanged into the cover glass substrate, the different monovalent ions may exchange to different depths within the cover glass substrate (and generate different magnitudes stresses within the cover glass substrate at different depths). The resulting relative depths of the stress-generating ions can be determined and cause different characteristics of the stress profile.

In one or more embodiments, the cover glass substrate has a CSₘₐₓ that is about 900 MPa or greater, about 920 MPa or greater, about 940 MPa or greater, about 950 MPa or greater, about 960 MPa or greater, about 980 MPa or greater, about 1000 MPa or greater, about 1020 MPa or greater, about 1040 MPa or greater, about 1050 MPa or greater, about 1060 MPa or greater, about 1080 MPa or greater, about 1100 MPa or greater, about 1120 MPa or greater, about 1140 MPa or greater, about 1150 MPa or greater, about 1160 MPa or greater, about 1180 MPa or greater, about 1200 MPa or greater, about 1220 MPa or greater, about 1240 MPa or greater, about 1250 MPa or greater, about 1260 MPa or greater, about 1280 MPa or greater, or about 1300 MPa or greater. In one or more embodiments, the CSₘₐₓ is in a range from about 900 MPa to about 1500 MPa, from about 920 MPa to about 1500 MPa, from about 940 MPa to about 1500 MPa, from about 950 MPa to about 1500 MPa, from about 960 MPa to about 1500 MPa, from about 980 MPa to about 1500 MPa, from about 1000 MPa to about 1500 MPa, from about 1020 MPa to about 1500 MPa, from about 1040 MPa to about 1500 MPa, from about 1050 MPa to about 1500 MPa, from about 1060 MPa to about 1500 MPa, from about 1080 MPa to about 1500 MPa, from about 1100 MPa to about 1500 MPa, from about 1120 MPa to about 1500 MPa, from about 1140 MPa to about 1500 MPa, from about 1150 MPa to about 1500 MPa, from about 1160 MPa to about 1500 MPa, from about 1180 MPa to about 1500 MPa, from about 1200 MPa to about 1500 MPa, from about 1220 MPa to about 1500 MPa, from about 1240 MPa to about 1500 MPa, from about 1250 MPa to about 1500 MPa, from about 1260 MPa to about 1500 MPa, from about 1280 MPa to about 1500 MPa, from about 1300 MPa to about 1500 MPa, from about 900 MPa to about 1480 MPa, from about 900 MPa to about 1460 MPa, from about 900 MPa to about 1450 MPa, from about 900 MPa to about 1440 MPa, from about 900 MPa to about 1420 MPa, from about 900 MPa to about 1400 MPa, from about 900 MPa to about 1380 MPa, from about 900 MPa to about 1360 MPa, from about 900 MPa to about 1350 MPa, from about 900 MPa to about 1340 MPa, from about 900 MPa to about 1320 MPa, from about 900 MPa to about 1300 MPa, from about 900 MPa to about 1280 MPa, from about 900 MPa to about 1260 MPa, from about 900 MPa to about 1250 MPa, from about 900 MPa to about 1240 MPa, from about 900 MPa to about 1220 MPa, from about 900 MPa to about 1210 MPa, from about 900 MPa to about 1200 MPa, from about 900 MPa to about 1180 MPa, from about 900 MPa to about 1160 MPa, from about 900 MPa to about 1150 MPa, from about 900 MPa to about 1140 MPa, from about 900 MPa to about 1120 MPa, from about 900 MPa to about 1100 MPa, from about 900 MPa to about 1080 MPa, from about 900 MPa to about 1060 MPa, from about 900 MPa to about 1050 MPa, or from about 950 MPa to about 1050 MPa, or from about 1000 MPa to about 1050 MPa. CSₘₐₓ may be measured at a major surface or may be found at a depth from the major surface within the CS region.

In one or more embodiments, the cover glass substrate has a stress profile with a CS magnitude of 800 MPa or greater at a depth within the cover glass substrate of about 10 micrometers from the first major surface 102 (CS₁₀). In one or more embodiments, the CS₁₀ is about 810 MPa or greater, about 820 MPa or greater, about 830 MPa or greater, about 840 MPa or greater, about 850 MPa or greater, about 860 MPa or greater, about 870 MPa or greater, about 880 MPa or greater, about 890 MPa or greater, or about 900 MPa or greater. In one or more embodiments, the CS₁₀ is in a range from about 800 MPa to about 1000 MPa, from about 825 MPa to about 1000 MPa, from about 850 MPa to about 1000 MPa, from about 875 MPa to about 1000 MPa, from about 900 MPa to about 1000 MPa, from about 925 MPa to about 1000 MPa, from about 950 MPa to about 1000 MPa, from about 800 MPa to about 975 MPa, from about 800 MPa to about 950 MPa, from about 800 MPa to about 925 MPa, from about 800 MPa to about 900 MPa, from about 800 MPa to about 875 MPa, or from about 800 MPa to about 850 MPa.

In one or more embodiments, the cover glass substrate has a stress profile with a CS magnitude of 700 MPa or greater, or about 750 MPa or greater at a depth within the glass article of about 5 micrometers from the first major surface 102 (CS₅). In one or more embodiments, the CS₅ is about 760 MPa or greater, about 770 MPa or greater, about 775 MPa or greater, about 780 MPa or greater, about 790 MPa or greater, about 800 MPa or greater, about 810 MPa or greater, about 820 MPa or greater, about 825 MPa or greater, or about 830 MPa or greater. In one or more embodiments, the CS₅ is in a range from about 700 MPa to about 900 MPa, from about 725 MPa to about 900 MPa, from about 750 MPa to about 900 MPa, from about 775 MPa to about 900 MPa, from about 800 MPa to about 900 MPa, from about 825 MPa to about 900 MPa, from about 850 MPa to about 900 MPa, from about 700 MPa to about 875 MPa, from about 700 MPa to about 850 MPa, from about 700 MPa to about 825 MPa, from about 700 MPa to about 800 MPa, from about 700 MPa to about 775 MPa, from about 750 to about 800 MPa, from about 750 MPa to about 850 MPa, or from about 700 MPa to about 750 MPa.

In one or more embodiments, the cover glass substrate has a stress profile with a CTₘₐₓ that is present or located at a depth within the cover glass substrate from the first major surface in a range from about 0.25 t to about 0.75 t. In one or more embodiments, CTₘₐₓ is present or located at a depth in a range from about 0.25 t to about 0.74 t, from about 0.25 t to about 0.72 t, from about 0.25 t to about 0.70 t, from about 0.25 t to about 0.68 t, from about 0.25 t to about 0.66 t, from about 0.25 t to about 0.65 t, from about 0.25 t to about 0.62 t, from about 0.25 t to about 0.60 t, from about 0.25 t to about 0.58 t, from about 0.25 t to about 0.56 t, from about 0.25 t to about 0.55 t, from about 0.25 t to about 0.54 t, from about 0.25 t to about 0.52 t, from about 0.25 t to about 0.50 t, from about 0.26 t to about 0.75 t, from about 0.28 t to about 0.75 t, from about 0.30 t to about 0.75 t, from about 0.32 t to about 0.75 t, from about 0.34 t to about 0.75 t, from about 0.35 t to about 0.75 t, from about 0.36 t to about 0.75 t, from about 0.38 t to about 0.75 t, from about 0.40 t to about 0.75 t, from about 0.42 t to about 0.75 t, from about 0.44 t to about 0.75 t, from about 0.45 t to about 0.75 t, from about 0.46 t to about 0.75 t, from about 0.48 t to about 0.50 t, from about 0.30 t to about 0.70 t, from about 0.35 t to about 0.65 t, from about 0.4 t to about 0.6 t, or from about 0.45 t to about 0.55 t. In one or more embodiments, the foregoing ranges for the location of CTₘₐₓ is present when the cover glass substrate is in a substantially flat configuration (e.g., the cover glass has a radius of curvature of greater than about 5000 mm, or greater than about 10,000 mm).

In one or more embodiments, the CTₘₐₓ magnitude is about 80 MPa or less, about 78 MPa or less, about 76 MPa or less, about 75 MPa or less, about 74 MPa or less, about 72 MPa or less, about 70 MPa or less, about 68 MPa or less, about 66 MPa or less, about 65 MPa or less, about 64 MPa or less, about 62 MPa or less, about 60 MPa or less, about 58 MPa or less, about 56 MPa or less, about 55 MPa or less, about 54 MPa or less, about 52 MPa or less, or about 50 MPa or less. In one or more embodiments, the CTₘₐₓ magnitude is in a range from about 40 MPa to about 80 MPa, from about 45 MPa to about 80 MPa, from about 50 MPa to about 80 MPa, from about 55 MPa to about 80 MPa, from about 60 MPa to about 80 MPa, from about 65 MPa to about 80 MPa, from about 70 MPa to about 80 MPa, from about 40 MPa to about 75 MPa, from about 40 MPa to about 70 MPa, from about 40 MPa to about 65 MPa, from about 40 MPa to about 60 MPa, from about 40 MPa to about 55 MPa, or from about 40 MPa to about 50 MPa. In one or more embodiments, the foregoing ranges the magnitude of CTmax is present when the cover glass substrate is in a substantially flat configuration (e.g., the cover glass substrate has a radius of curvature of greater than about 5000 mm, or greater than about 10,000 mm).

In one or more embodiments, a portion of the stress profile has a parabolic-like shape. In some embodiments, the stress profile is free of a flat stress (i.e., compressive or tensile) portion or a portion that exhibits a substantially constant stress (i.e., compressive or tensile). In some embodiments, the CT region exhibits a stress profile that is substantially free of a flat stress or free of a substantially constant stress. In one or more embodiments, the stress profile is substantially free of any linear segments that extend in a depth direction or along at least a portion of the thickness of the cover glass. In other words, the stress profile is substantially continuously increasing or decreasing along the thickness. In some embodiments, the stress profile is substantially free of any linear segments in a depth direction having a length of about 10 micrometers or more, about 50 micrometers or more, or about 100 micrometers or more, or about 200 micrometers or more. As used herein, the term “linear” refers to a slope having a magnitude of less than about 5 MPa/micrometer, or less than about 2 MPa/micrometer along the linear segment. In some embodiments, one or more portions of the stress profile that are substantially free of any linear segments in a depth direction are present at depths within the cover glass of about 5 micrometers or greater (e.g., 10 micrometers or greater, or 15 micrometers or greater) from either one or both the first surface and the second surface. For example, along a depth of about 0 micrometers to less than about 5 micrometers from the first surface, the stress profile may include linear segments, but from a depth of about 5 micrometers or greater from the first surface, the stress profile may be substantially free of linear segments.

In one or more embodiments, all points of the CT region within 0.1 t, 0.15 t, 0.2 t, or 0.25 t from the depth of CTₘₐₓ comprise a tangent having a non-zero slope. In one or more embodiments, all such points comprise a tangent having a slope that is greater than about 0.5 MPa/micrometer in magnitude, greater than about 0.75 MPa/micrometer in magnitude, greater than about 1 MPa/micrometer in magnitude, greater than about 1.5 MPa/micrometer in magnitude, or greater about 2 MPa/micrometer in magnitude than, or greater than about 0.5 MPa/micrometer in magnitude.

In one or more embodiments, all points of the stress profile at a depth from about 0.12 t or greater (e.g., from about 0.12 t to about 0.24 t, from about 0.14 t to about 0.24 t, from about 0.15 t to about 0.24 t, from about 0.16 t to about 0.24 t, from about 0.18 t to about 0.24 t, from about 0.12 t to about 0.22 t, from about 0.12 t to about 0.2 t, from about 0.12 t to about 0.18 t, from about 0.12 t to about 0.16 t, from about 0.12 t to about 0.15 t, from about 0.12 t to about 0.14 t, or from about 0.15 t to about 0.2 t) comprise a tangent having a non-zero slope.

In one or more embodiments, the DOC of the cover glass substrate is about 0.2 t or less. For example, DOC may be about 0.18 t or less, about 0.18 t or less, about 0.16 t or less, about 0.15 t or less, about 0.14 t or less, about 0.12 t or less, about 0.1 t or less, about 0.08 t or less, about 0.06 t or less, about 0.05 t or less, about 0.04 t or less, or about 0.03 t or less. In one or more embodiments, DOC is in a range from about 0.02 t to about 0.2 t, from about 0.04 t to about 0.2 t, from about 0.05 t to about 0.2 t, from about 0.06 t to about 0.2 t, from about 0.08 t to about 0.2 t, from about 0.1 t to about 0.2 t, from about 0.12 t to about 0.2 t, from about 0.14 t to about 0.2 t, from about 0.15 t to about 0.2 t, from about 0.16 t to about 0.2 t, from about 0.02 t to about 0.18 t, from about 0.02 t to about 0.16 t, from about 0.02 t to about 0.15 t, from about 0.02 t to about 0.14 t, from about 0.02 t to about 0.12 t, from about 0.02 t to about 0.1 t, from about 0.02 t to about 0.08, from about 0.02 t to about 0.06 t, from about 0.02 t to about 0.05 t, from about 0.1 t to about 0.8 t, from about 0.12 t to about 0.16 t, or from about 0.14 t to about 0.17 t.

In one or more embodiments, the cover glass substrate has a DOL that is in a range from about 10 micrometers to about 50 micrometers, from about 12 micrometers to about 50 micrometers, from about 14 micrometers to about 50 micrometers, from about 15 micrometers to about 50 micrometers, from about 16 micrometers to about 50 micrometers, from about 18 micrometers to about 50 micrometers, from about 20 micrometers to about 50 micrometers, from about 22 micrometers to about 50 micrometers, from about 24 micrometers to about 50 micrometers, from about 25 micrometers to about 50 micrometers, from about 26 micrometers to about 50 micrometers, from about 28 micrometers to about 50 micrometers, from about 30 micrometers to about 50 micrometers, from about 10 micrometers to about 48 micrometers, from about 10 micrometers to about 46 micrometers, from about 10 micrometers to about 45 micrometers, from about 10 micrometers to about 44 micrometers, from about 10 micrometers to about 42 micrometers, from about 10 micrometers to about 40 micrometers, from about 10 micrometers to about 38 micrometers, from about 10 micrometers to about 36 micrometers, from about 10 micrometers to about 35 micrometers, from about 10 micrometers to about 34 micrometers, from about 10 micrometers to about 32 micrometers, from about 10 micrometers to about 30 micrometers, from about 10 micrometers to about 28 micrometers, from about 10 micrometers to about 26 micrometers, from about 10 micrometers to about 25 micrometers, from about 20 micrometers to about 40 micrometers, from about 25 micrometers to about 40 micrometers, from about 20 micrometers to about 35 micrometers, or from about 25 micrometers to about 35 micrometers. In one or more embodiments, at least a portion of the stress profile comprises a spike region 120 extending from the first major surface, a tail region 124 and a knee region 122 between the spike region and the tail region, as illustrated in FIG. 3. The spike region 120 is within the CS region of the stress profile. In one or more embodiments, wherein all points of the stress profile in the spike region comprise a tangent having a slope in magnitude that is in a range from about 15 MPa/micrometer to about 200 MPa/micrometer, from about 20 MPa/micrometer to about 200 MPa/micrometer, from about 25 MPa/micrometer to about 200 MPa/micrometer, from about 30 MPa/micrometer to about 200 MPa/micrometer, from about 35 MPa/micrometer to about 200 MPa/micrometer, from about 40 MPa/micrometer to about 200 MPa/micrometer, from about 45 MPa/micrometer to about 200 MPa/micrometer, from about 100 MPa/micrometer to about 200 MPa/micrometer, from about 150 MPa/micrometer to about 200 MPa/micrometer, from about 15 MPa/micrometer to about 190 MPa/micrometer, from about 15 MPa/micrometer to about 180 MPa/micrometer, from about 15 MPa/micrometer to about 170 MPa/micrometer, from about 15 MPa/micrometer to about 160 MPa/micrometer, from about 15 MPa/micrometer to about 150 MPa/micrometer, from about 15 MPa/micrometer to about 140 MPa/micrometer, from about 15 MPa/micrometer to about 130 MPa/micrometer, from about 15 MPa/micrometer to about 120 MPa/micrometer, from about 15 MPa/micrometer to about 100 MPa/micrometer, from about 15 MPa/micrometer to about 750 MPa/micrometer, from about 15 MPa/micrometer to about 50 MPa/micrometer, from about 50 MPa/micrometer to about 150 MPa/micrometer, or from about 75 MPa/micrometer to about 125 MPa/micrometer.

In one or more embodiments, and all points in the tail region comprise a tangent having a slope in magnitude that is in a range from about 0.01 MPa/micrometer to about 3 MPa/micrometer, from about 0.05 MPa/micrometer to about 3 MPa/micrometer, from about 0.1 MPa/micrometer to about 3 MPa/micrometer, from about 0.25 MPa/micrometer to about 3 MPa/micrometer, from about 0.5 MPa/micrometer to about 3 MPa/micrometer, from about 0.75 MPa/micrometer to about 3 MPa/micrometer, from about 1 MPa/micrometer to about 3 MPa/micrometer, from about 1.25 MPa/micrometer to about 3 MPa/micrometer, from about 1.5 MPa/micrometer to about 3 MPa/micrometer, from about 1.75 MPa/micrometer to about 3 MPa/micrometer, from about 2 MPa/micrometer to about 3 MPa/micrometer, from about 0.01 MPa/micrometer to about 2.9 MPa/micrometer, from about 0.01 MPa/micrometer to about 2.8 MPa/micrometer, from about 0.01 MPa/micrometer to about 2.75 MPa/micrometer, from about 0.01 MPa/micrometer to about 2.7 MPa/micrometer, from about 0.01 MPa/micrometer to about 2.6 MPa/micrometer, from about 0.01 MPa/micrometer to about 2.5 MPa/micrometer, from about 0.01 MPa/micrometer to about 2.4 MPa/micrometer, from about 0.01 MPa/micrometer to about 2.2 MPa/micrometer, from about 0.01 MPa/micrometer to about 2.1 MPa/micrometer, from about 0.01 MPa/micrometer to about 2 MPa/micrometer, from about 0.01 MPa/micrometer to about 1.75 MPa/micrometer, from about 0.01 MPa/micrometer to about 1.5 MPa/micrometer, from about 0.01 MPa/micrometer to about 1.25 MPa/micrometer, from about 0.01 MPa/micrometer to about 1 MPa/micrometer, from about 0.01 MPa/micrometer to about 0.75 MPa/micrometer, from about 0.01 MPa/micrometer to about 0.5 MPa/micrometer, from about 0.01 MPa/micrometer to about 0.25 MPa/micrometer, from about 0.1 MPa/micrometer to about 2 MPa/micrometer, from about 0.5 MPa/micrometer to about 2 MPa/micrometer, or from about 1 MPa/micrometer to about 3 MPa/micrometer.

In one or more embodiments, the CS magnitude within the spike region is in a range from about greater than 200 MPa to about 1500 MPa. For example, the CS magnitude in the spike region may be in a range from about 250 MPa to about 1500 MPa, from about 300 MPa to about 1500 MPa, from about 350 MPa to about 1500 MPa, from about 400 MPa to about 1500 MPa, from about 450 MPa to about 1500 MPa, from about 500 MPa to about 1500 MPa, from about 550 MPa to about 1500 MPa, from about 600 MPa to about 1500 MPa, from about 750 MPa to about 1500 MPa, from about 800 MPa to about 1500 MPa, from about 850 MPa to about 1500 MPa, from about 900 MPa to about 1500 MPa, from about 950 MPa to about 1500 MPa, from about 1000 MPa to about 1500 MPa, from about 1050 MPa to about 1500 MPa, from about 1100 MPa to about 1500 MPa, from about 1200 MPa to about 1500 MPa, from about 250 MPa to about 1450 MPa, from about 250 MPa to about 1400 MPa, from about 250 MPa to about 1350 MPa, from about 250 MPa to about 1300 MPa, from about 250 MPa to about 1250 MPa, from about 250 MPa to about 1200 MPa, from about 250 MPa to about 1150 MPa, from about 250 MPa to about 1100 MPa, from about 250 MPa to about 1050 MPa, from about 250 MPa to about 1000 MPa, from about 250 MPa to about 950 MPa, from about 250 MPa to about 90 MPa, from about 250 MPa to about 850 MPa, from about 250 MPa to about 800 MPa, from about 250 MPa to about 750 MPa, from about 250 MPa to about 700 MPa, from about 250 MPa to about 650 MPa, from about 250 MPa to about 600 MPa, from about 250 MPa to about 550 MPa, from about 250 MPa to about 500 MPa, from about 800 MPa to about 1400 MPa, from about 900 MPa to about 1300 MPa, from about 900 MPa to about 1200 MPa, from about 900 MPa to about 1100 MPa, or from about 900 MPa to about 1050 MPa.

In one or more embodiments, the CS magnitude in the knee region is in a range from about 5 MPa to about 200 MPa, from about 10 MPa to about 200 MPa, from about 15 MPa to about 200 MPa, from about 20 MPa to about 200 MPa, from about 25 MPa to about 200 MPa, from about 30 MPa to about 200 MPa, from about 35 MPa to about 200 MPa, from about 40 MPa to about 200 MPa, from about 45 MPa to about 200 MPa, from about 50 MPa to about 200 MPa, from about 55 MPa to about 200 MPa, from about 60 MPa to about 200 MPa, from about 65 MPa to about 200 MPa, from about 75 MPa to about 200 MPa, from about 80 MPa to about 200 MPa, from about 90 MPa to about 200 MPa, from about 100 MPa to about 200 MPa, from about 125 MPa to about 200 MPa, from about 150 MPa to about 200 MPa, from about 5 MPa to about 190 MPa, from about 5 MPa to about 180 MPa, from about 5 MPa to about 175 MPa, from about 5 MPa to about 170 MPa, from about 5 MPa to about 160 MPa, from about 5 MPa to about 150 MPa, from about 5 MPa to about 140 MPa, from about 5 MPa to about 130 MPa, from about 5 MPa to about 125 MPa, from about 5 MPa to about 120 MPa, from about 5 MPa to about 110 MPa, from about 5 MPa to about 100 MPa, from about 5 MPa to about 75 MPa, from about 5 MPa to about 50 MPa, from about 5 MPa to about 25 MPa, or from about 10 MPa to about 100 MPa.

In one or more embodiments, the knee region of the stress profile extends from about 10 micrometers to about 50 micrometers from the first major surface. For example, the knee region of the stress profile extends from about 12 micrometers to about 50 micrometers, from about 14 micrometers to about 50 micrometers, from about 15 micrometers to about 50 micrometers, from about 16 micrometers to about 50 micrometers, from about 18 micrometers to about 50 micrometers, from about 20 micrometers to about 50 micrometers, from about 22 micrometers to about 50 micrometers, from about 24 micrometers to about 50 micrometers, from about 25 micrometers to about 50 micrometers, from about 26 micrometers to about 50 micrometers, from about 28 micrometers to about 50 micrometers, from about 30 micrometers to about 50 micrometers, from about 32 micrometers to about 50 micrometers, from about 34 micrometers to about 50 micrometers, from about 35 micrometers to about 50 micrometers, from about 36 micrometers to about 50 micrometers, from about 38 micrometers to about 50 micrometers, from about 40 micrometers to about 50 micrometers, from about 10 micrometers to about 48 micrometers, from about 10 micrometers to about 46 micrometers, from about 10 micrometers to about 45 micrometers, from about 10 micrometers to about 44 micrometers, from about 10 micrometers to about 42 micrometers, from about 10 micrometers to about 40 micrometers, from about 10 micrometers to about 38 micrometers, from about 10 micrometers to about 36 micrometers, from about 10 micrometers to about 35 micrometers, from about 10 micrometers to about 34 micrometers, from about 10 micrometers to about 32 micrometers, from about 10 micrometers to about 30 micrometers, from about 10 micrometers to about 28 micrometers, from about 10 micrometers to about 26 micrometers, from about 10 micrometers to about 25 micrometers, from about 10 micrometers to about 24 micrometers, from about 10 micrometers to about 22 micrometers, or from about 10 micrometers to about 20 micrometers, from the first major surface.

In one or more embodiments, the tail region extends from about the knee region to the depth of CTₘₐₓ. In one or more embodiments, the tail region comprises one or both of a compressive stress tail region, and a tensile stress tail region.

In one or more embodiments, the cold-formed cover glass substrate includes a display, touch panel or a combination thereof disposed adjacent one or both of the first major surface or the second major surface. In one or more embodiments, the display, touch panel or combination thereof is disposed along the first portion, any two of the first portion, second portion and third portion, or all three of the first portion, the second portion and the third portion. The display, touch panel or combination thereof may be flat or curved. In one or embodiments, the display, touch panel or combination thereof has a radius of curvature that is within 10% of the radius of curvature of the of the portion of the first or second major surface of the cold-formed cover glass substrate to which the display, touch panel or combination thereof is adjacently disposed. In one or more embodiments, an air gap is disposed between the display, touch panel or a combination thereof and the first major surface or the second major surface. In one or more embodiments, the display, touch panel or a combination thereof is attached directly to one or both of the first major surface or the second major surface. Such attachment may be through use of an adhesive, such as, for example, an optically clear adhesive. In one or more embodiments, the display, touch panel or a combination thereof is attached directly to one or both of the first major surface or the second major surface but includes an intervening air gap in some portions (e.g., the display viewing area may include an air gap while the non-viewing areas may include an adhesive by which the display is attached directly to the first major surface or the second major surface). In one or more embodiments, the display may be a liquid crystal display, an organic light-emitting diode (OLED) display, a transmissive display or other display.

In one or more embodiments, the cold-formed cover glass substrate includes one or more sensors disposed adjacent one or both of the first major surface or the second major surface. In one or more embodiments, the sensor may comprise a radar sensor (e.g., short range and long range radar sensors), a light detection and ranging (LiDAR) sensor, an ultrasonic sensor, a proximity sensor (e.g., electromagnetic wave-emitting sensors), an infrared sensor, and an image sensor.

In one or more embodiments, the cold-formed cover glass substrate includes a structural support to maintain the curvature of the portions of the cold-formed cover glass substrate. The structural support may be formed from a stiff plastic material and/or a metal (e.g., steel, steel alloy, magnesium, magnesium alloy, aluminum, aluminum alloy or any other known metal used in the automotive industry or an alloy thereof). In one or more embodiments, the structural support may be stiffened by including ribs or other structures to provide increased stiffness to the support. In one or more embodiments, an adhesive (e.g., a structural adhesive) or other fastener may be disposed between the cold-formed cover glass substrate and the structural support to attach or adhere the cold-formed cover glass substrate in a curved shape (as described herein) to a support surface of the structural support, which provides and maintains the shape of the cold-formed cover glass substrate. In one or more embodiments, an adhesive may be between the cover glass substrate and the display and/or touch panel. Such adhesive may be optically clear.

In one or more embodiments, the surface area of the support surface of the structural support may be minimized by the shape and dimensions of the second portion of the cold-formed cover glass substrate. Such minimized surface area can still provide and maintain the curvatures ad shape of the cold-form cover glass substrate, thereby leaving a large majority of the first and second major surfaces of the cold-formed cover glass substrate available for viewing an underlying display and/or accessing an underlying touch panel. In one or more embodiments, the shape and dimensions of the second portion of the cold-formed cover glass substrate described herein reduces the stress on the adhesive that may be used attach or adhere the cold-formed cover glass substrate to the structural support, thereby enabling enhanced durability of the assembly and the use of a structural support with a support surface having minimized surface area. In one or more embodiments, the smallest dimension of the support surface may be less than about 15 mm. In one or more embodiments, the smallest dimension of the support surface may be about 12 mm or less, 10 mm or less, 9 mm or less, 8 mm or less, 7 mm or less, 6 mm or less, 5 mm or less, 4 mm or less, 3 mm or less, or about 2 mm or less. Exemplary support structures are described in U.S. Provisional Patent Application No. 63/014,401, entitled “GLASS ARTICLE HAVING FRAME CONFIGURED FOR MINIMAL SHAPE DEVIATION AND HAVING SMALL BEZEL WIDTH,” filed on Apr. 23, 2020, which is incorporated by reference in its entirety as if fully set forth herein.

In this regard, in one or more embodiments, the adhesive disposed between the cold-formed cover glass substrate and the support surface of the structural support exhibits or comprises an adhesive stress (which includes both shear and tensile stresses) that decreases from the first axis to the second axis. In such embodiments, the second radius of curvature of the second portion increases from the first axis to the second axis and may, in some embodiments, be greater than 30,000 mm or may approach infinity (i.e., such that cold-formed cover glass substrate is substantially flat at or near the second axis). In one or more embodiments, the adhesive stress decreases by a magnitude of about 2 MPa, 1.5 MPa, about 1.4 MPa, about 1.3 MPa, about 1.2 MPa, about 1.1 MPa, about 1.0 MPa, about 0.9 MPa, about 0.8 MPa, about 0.7 MPa, about 0.6 MPa, about 0.5 MPa, about 0.4 MPa, about 0.3 MPa, about 0.2 MPa, or about 0.1 MPa. In one or more specific embodiments, where the radius of curvature at or near the second axis is greater than 30,000 mm or approaches infinity, the adhesive stress on the cold-formed cover glass substrate at the first axis may be in a range from about 0.5 MPa to about 2 MPa and the surface stress at the second axis may be less than about 0.5 MPa, less than about 0.25 MPa, or about 0 MPa. Accordingly, in one or more embodiments, the surface stress may decrease from the first axis to the second axis from about 2 MPa to about 0 MPa, from about 1.9 MPa to about 0 MPa, from about 1.8 MPa to about 0 MPa, from about 1.7 MPa to about 0 MPa, from about 1.6 MPa to about 0 MPa, from about 1.5 MPa to about 0 MPa, from about 1.4 MPa to about 0 MPa, from about 1.3 MPa to about 0 MPa, from about 1.2 MPa to about 0 MPa, from about 1.1 MPa to about 0 MPa, from about 1 MPa to about 0 MPa, from about 0.9 MPa to about 0 MPa, from about 0.8 MPa to about 0 MPa, from about 0.7 MPa to about 0 MPa, from about 0.6 MPa to about 0 MPa, from about 0.5 MPa to about 0 MPa, from about 0.4 MPa to about 0 MPa, from about 0.3 MPa to about 0 MPa, from about 0.2 MPa to about 0 MPa, or from about 0.1 MPa to about 0 MPa.

Exemplary adhesives include polyurethanes (e.g., DP604NS available from 3M®, Saint Paul, Minn., as well as Betamate 73100/002, 73100/005, 73100/010, Betaseal X2500, and Betalink K2, from Dupont®, Wilmington, Del.), polysiloxanes and silane-modified polymers (e.g., TEROSON RB IX, also known as TEROSTAT MS 9399 and TEROSON MS 647, available from Loctite®), and epoxies (e.g., Scotch-Weld™ Epoxy Adhesive DP125 and DP604 available from 3M®, Saint Paul, Minn.).

Additional adhesives include, but not limited to, an adhesive selected from one of more of the categories: (a) Toughened Epoxy (for example, MasterbondEP21TDCHT-LO, 3M Scotch Weld Epoxy DP460 Off-white); (b) Flexible Epoxy (for example, Masterbond EP21TDC-2LO, 3M Scotch Weld Epoxy 2216); (c) Acrylics and/or Toughened Acrylics (for example, LORD Adhesive 403, 406 or 410 Acrylic adhesives with LORD Accelerator 19 or 19 GB w/LORD AP 134 primer, LORD Adhesive 850 or 852/LORD Accelerator 25 GB, Loctite HF8000, Loctite AA4800); (d) Urethanes (for example, 3M Scotch Weld Urethane DP640 Brown, SikaForce 7570 L03, SikaForce 7550 L15, Sikaflex 552 and Polyurethane (PUR) Hot Melt adhesives such as, Technomelt PUR 9622-02 UVNA, Loctite HHD 3542, Loctite HHD 3580, 3M Hotmelt adhesives 3764 and 3748); and (e) Silicones (Dow Corning 995, Dow Corning 3-0500 Silicone Assembly adhesive, Dow Corning 7091, SikaSil-GP). In some cases, structural adhesives available as sheets or films (for example, but not limited to, 3M Structural adhesive films AF126-2, AF 163-2M, SBT 9263 and 9214, Masterbond FLM36-LO) may be utilized. Furthermore, pressure sensitive adhesives such as 3M VHB tapes may be utilized. In such embodiments, utilizing a pressure sensitive adhesive allows for the cold-formed cover glass substrate to be bonded to structural support without the need for, among other things, a curing step.

In one or more embodiments, the cold-formed cover glass, when assembled with a structural support exhibits certain mechanical performance. In one or more embodiments, when an impactor having a mass of 6.8 kg impacts the first major surface at an impact velocity of 5.35 m/s to 6.69 m/s, the glass article is elastically deformed. In one or more embodiments, the deceleration of the impactor is 120 g (g-force) or less or is not greater than 80 g for any 3 ms interval over a time of impact.

Another aspect of this disclosure pertains to an automotive interior system including a base, and a cold-formed cover glass substrate according to one or more embodiments described herein, disposed on the base. In one or more embodiments, when an impactor having a mass of 6.8 kg impacts the first major surface at an impact velocity of 5.35 m/s to 6.69 m/s, the deceleration of the impactor is 120 g (g-force) or less or is not greater than 80 g for any 3 millisecond (ms) interval over a time of impact. In one or more embodiments, the base is curved or flat. An exemplary base may be one of a dashboard, an arm rest, a pillar, a seat back, a floor board, a headrest, or a door panel. In one or more embodiments, the system comprises an infotainment system.

### EXAMPLES

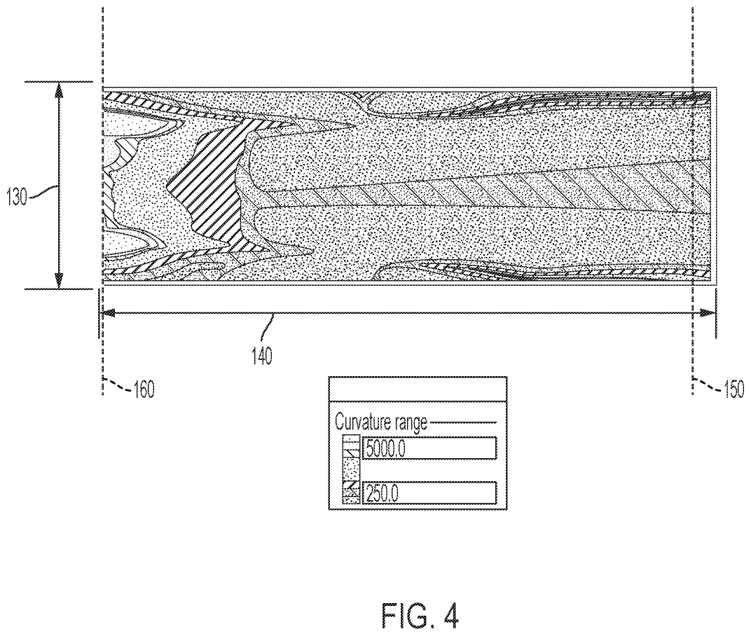

Example 1 is a cold-formed cover glass substrate that includes a first axis 150 and second axis 160 that both extend along the width 130 of the substrate. The radius of curvature along the width 130 of the second portion was measured from the first axis 150 to the second axis. The measurements (in mm) are shown in FIG. 4. As shown in FIG. 4, the radius of curvature increases from the first axis 150 to the second axis 160.

The radius of curvature along the length 140 of the second portion was measured from the third axis 135 and the fourth axis 137. The measurements (in mm) are shown in FIG. 5. As shown in FIG. 5, the radius of curvature decreases (and approaches zero) at specific locations adjacent the second axis 160 and increases (and approaches infinity) at specific locations adjacent the first axis 150. For illustration, FIG. 5 shows areas near the second axis having a radius of curvature of 1500 mm or less, and areas near the first axis having a radius of curvature of 1.5×10⁶ mm and greater. As described herein, the first axis 150 is adjacent the third portion 190. The increase in radius of curvature a locations moving from the second axis to the first axis in FIG. 5 shows the radius of curvature along the length 140 is not constant and thus the cold-formed cover glass substrate has a compound curvature.

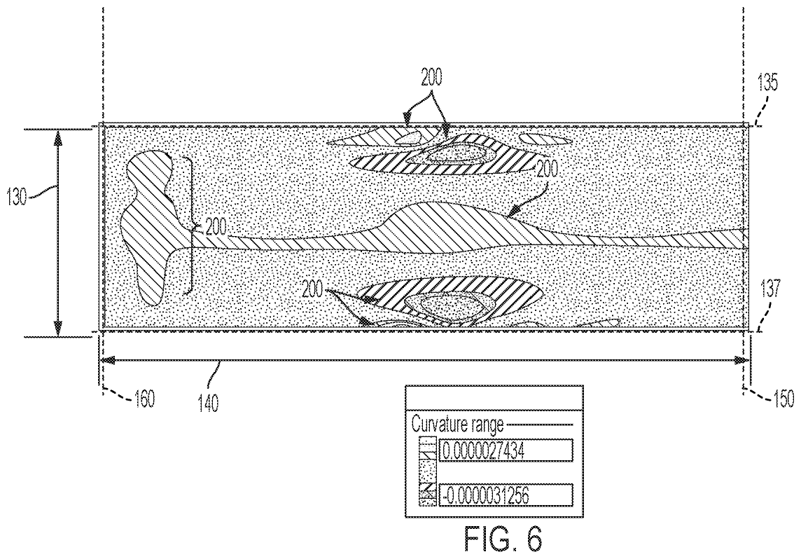

FIG. 6 shows the substrate Gaussian curvature of the cold-formed cover glass substrate of Example 1. As shown in FIG. 6, the cold-formed cover glass substrate of Example 1 comprises a non-zero substrate Gaussian curvature in a regions 200 approaching the second axis 160 and mid-distance from the first axis 150 to the second axis. In particular, regions 200 of the first and second major surface exhibit a substrate Gaussian curvature that is from greater than zero up to 0.313×10⁻⁶.

Aspect (1) of this disclosure pertains to a cold-formed cover glass substrate comprising: a first end; a second end opposing the second end; a first major surface extending from the first end to the second end, a second major surface opposing the first major surface, a minor surface connecting the first major surface and the second major surface, a thickness defined as a distance between the first major surface and the second major surface, a width defined as a first dimension of one of the first or second major surfaces orthogonal to the thickness, a length defined as a second dimension of one of the first or second major surfaces orthogonal to both the thickness and the width; a first axis and a second axis, the first and second axis both extending along the width or the length; a first portion extending from the first axis to the first end, the first portion comprising a first radius of curvature in a range from about 20 mm to about 20,000 mm; a second portion extending from the first axis to the second axis, the second portion comprising a second radius of curvature that increases or decreases from the first axis to the second axis.

Aspect (2) of this disclosure pertains to the cold-formed cover glass substrate of Aspect (1), wherein the first axis and the second axis are disposed between the first end and the second end.

Aspect (3) of this disclosure pertains to the cold-formed cover glass substrate of Aspect (1), wherein the first axis is disposed between the first and second ends, and the second axis is disposed at the second end.

Aspect (4) of this disclosure pertains to the cold-formed cover glass substrate of any one of Aspects (1) through (3), wherein the distance between the first axis and the second axis is about 100 micrometers (m) or less.

Aspect (5) of this disclosure pertains to the cold-formed cover glass substrate of any one of Aspects (1) through (4), wherein the distance between the first axis and the second axis is about 10 micrometers (m) or less.

Aspect (6) of this disclosure pertains to the cold-formed cover glass substrate of any one of Aspects (1) through (5), wherein the second radius of curvature is in a range from the first radius of curvature to infinity.

Aspect (7) of this disclosure pertains to the cold-formed cover glass substrate of Aspect (6), wherein the second radius of curvature is in a range from the first radius of curvature to about 30,000 mm.

Aspect (8) of this disclosure pertains to the cold-formed cover glass substrate of any one of Aspects (1) through (7), wherein one or both of the first portion and the second portion comprises a substrate Gaussian curvature, wherein the substrate Gaussian curvature has an absolute value in a range from greater than zero to about 3×10⁻⁶.

Aspect (9) of this disclosure pertains to the cold-formed cover glass substrate of any one of Aspects (1) through (8), wherein either one of or both the first major surface and the second major surface comprises a surface treatment.

Aspect (10) of this disclosure pertains to the cold-formed cover glass substrate of Aspect (9), wherein the surface treatment covers at least a portion of the first major surface and the second major surface.

Aspect (11) of this disclosure pertains to the cold-formed cover glass substrate of Aspect (9) or Aspect (10), wherein the surface treatment comprises any one of an easy-to-clean surface, an anti-glare surface, an anti-reflective surface, a haptic surface, and a decorative surface.

Aspect (12) of this disclosure pertains to the cold-formed cover glass substrate of any one of Aspects (1) through (11), wherein the cold-formed cover glass substrate is substantially free of an anti-splinter film.

Aspect (13) of this disclosure pertains to the cold-formed cover glass substrate of any one of Aspects (1) through (12), wherein the glass is strengthened.

Aspect (14) of this disclosure pertains to the cold-formed cover glass substrate of any one of Aspects (2) or (4) through (13), further comprising a third portion disposed between the second end and the second axis, wherein the third portion comprises a third radius of curvature that differs from the first radius of curvature.

Aspect (15) of this disclosure pertains to the cold-formed cover glass substrate of Aspect (14), wherein the first portion comprises a concave curvature and the third portion comprises a convex curvature.

Aspect (16) of this disclosure pertains to the cold-formed cover glass substrate of Aspect (14), wherein the first portion comprises a convex curvature and the third portion comprises a concave curvature.

Aspect (17) of this disclosure pertains to the cold-formed cover glass substrate of Aspect (14), wherein the first portion and the third portion comprise a convex curvature.

Aspect (18) of this disclosure pertains to the cold-formed cover glass substrate of Aspect (14), wherein the first portion and the third portion comprise a concave curvature.

Aspect (19) of this disclosure pertains to the cold-formed cover glass substrate of any one of Aspects (14) through (18), wherein the third radius of curvature is in a range from about 20 mm to 30,000 mm.

Aspect (20) of this disclosure pertains to the cold-formed cover glass substrate of any one of Aspects (1) through (19), further comprising a display, touch panel or a combination thereof disposed adjacent one or both of the first major surface or the second major surface.

Aspect (21) of this disclosure pertains to the cold-formed cover glass substrate of any one of Aspects (1) through (20), further comprising a sensor disposed adjacent one or both of the first major surface or the second major surface.

Aspect (22) of this disclosure pertains to the cold-formed cover glass substrate of any one of Aspects (14) through (21), wherein the third portion comprises a second glass substrate attached to one or both of the first and second major surfaces.

Aspect (23) of this disclosure pertains to the cold-formed cover glass substrate of any one of Aspects (1) through (22), wherein, when an impactor having a mass of 6.8 kg impacts the first major surface at an impact velocity of 5.35 m/s to 6.69 m/s, the deceleration of the impactor is 120 g (g-force) or less.

Aspect (24) of this disclosure pertains to the cold-formed cover glass substrate of Aspect (23), wherein the deceleration of the impactor is not greater than 80 g for any 3 ms interval over a time of impact.

Aspect (25) of this disclosure pertains to a cold-formed cover glass substrate comprising: a first end; a second end opposing the first end; a first major surface extending the first end to the second end, a second major surface opposing the first major surface, a minor surface connecting the first major surface and the second major surface, a thickness defined as a distance between the first major surface and the second major surface, a width defined as a first dimension of one of the first or second major surfaces orthogonal to the thickness, a length defined as a second dimension of one of the first or second major surfaces orthogonal to both the thickness and the width; a first axis and a second axis, the first axis and the second axis both extending along the width or the length; a first portion extending from the first axis to the first end, the first portion comprising a first radius of curvature in a range from about 20 mm to about 20,000 mm; a second portion extending from the first axis to the second axis; and a third portion extending from the second axis to the second end, wherein the third portion comprises a third radius of curvature in a range from about 20 mm to about 20,000 mm, and wherein the first portion and the third portion differ from one another.

Aspect (26) of this disclosure pertains to the cold-formed cover glass substrate of Aspect (25), wherein the cold-formed cover glass substrate comprises one or more of: the first radius of curvature and the third radius of curvature differ from one another in magnitude, the first portion, the second portion or the third portion comprises a non-zero substrate Gaussian curvature, and the first portion comprises a concave shape or a convex shape and the third portion comprises the other of a concave shape or a convex shape.

Aspect (27) of this disclosure pertains to the cold-formed cover glass substrate of Aspect (25), wherein the substrate Gaussian curvature is an absolute value in a range from greater than zero to about 3×10⁻⁶.

Aspect (28) of this disclosure pertains to the cold-formed cover glass substrate of Aspect (27), further comprising a support structure comprising a support surface that is attached to the first major surface of the first portion, the second portion or the third portion and forms an interface, wherein along the interface, the first major surface comprises the substrate Gaussian curvature and the support surface comprises a support Gaussian curvature that is within 10% of the substrate Gaussian curvature.

Aspect (29) of this disclosure pertains to the cold-formed cover glass substrate of any one of Aspects (25) through (28), wherein the second portion is curved, and comprises the substrate Gaussian curvature.

Aspect (30) of this disclosure pertains to the cold-formed cover glass substrate of any one of Aspects (25) through (29), wherein the first portion and the third portion are oriented along two bend axes that differ from one another.

Aspect (31) of this disclosure pertains to the cold-formed cover glass substrate of Aspect (30), wherein the two bend axes are perpendicular.

Aspect (32) of this disclosure pertains to the cold-formed cover glass substrate of Aspect (31), wherein the two bend axes are parallel.

Aspect (33) of this disclosure pertains to the cold-formed cover glass substrate of any one of Aspects (25) through (32), wherein the second portion is curved and comprises a second radius of curvature that increases or decreases from the first axis to the second axis.

Aspect (34) of this disclosure pertains to the cold-formed cover glass substrate of any one of Aspects (25) through (33), wherein the first axis and the second axis are disposed between the first and second ends.

Aspect (35) of this disclosure pertains to the cold-formed cover glass substrate of any one of Aspects (25) through (33), wherein the first axis is disposed between the first and second ends, and the second axis is disposed at the second end.

Aspect (36) of this disclosure pertains to the cold-formed cover glass substrate of any one of Aspects (25) through (35), wherein the distance between the first axis and the second axis is about 100 micrometers (μm) or less.

Aspect (37) of this disclosure pertains to the cold-formed cover glass substrate of Aspect (36), wherein the distance between the first axis and the second axis is about 10 micrometers (μm) or less.

Aspect (38) of this disclosure pertains to the cold-formed cover glass substrate of any one of Aspects (33) through (37), wherein the second radius of curvature is in a range from the first radius of curvature to infinity.

Aspect (39) of this disclosure pertains to the cold-formed cover glass substrate of any one of Aspects (33) through (38), wherein the second radius of curvature is in a range from the first radius of curvature to 30,000 mm.

Aspect (40) of this disclosure pertains to the cold-formed cover glass substrate of any one of Aspects (25) through (39), wherein either one of or both the first major surface and the second major surface comprises a surface treatment.

Aspect (41) of this disclosure pertains to the cold-formed cover glass substrate of Aspect (40), wherein the surface treatment covers at least a portion of the first major surface and the second major surface.

Aspect (42) of this disclosure pertains to the cold-formed cover glass substrate of Aspect (40) or Aspect (41), wherein the surface treatment comprises any one of an easy-to-clean surface, an anti-glare surface, an anti-reflective surface, a haptic surface, and a decorative surface.

Aspect (43) of this disclosure pertains to the cold-formed cover glass substrate of any one of Aspects (25) through (42), wherein the cold-formed cover glass substrate is substantially free of an anti-splinter film.

Aspect (44) of this disclosure pertains to the cold-formed cover glass substrate of any one of Aspects (25) through (43), wherein the glass is strengthened.

Aspect (45) of this disclosure pertains to the cold-formed cover glass substrate of any one of Aspects (25) through (44), wherein the first portion comprises a concave curvature and the third portion comprises a convex curvature.

Aspect (46) of this disclosure pertains to the cold-formed cover glass substrate of any one of Aspects (25) through (45), wherein the first portion comprises a convex curvature and the third portion comprises a concave curvature.

Aspect (47) of this disclosure pertains to the cold-formed cover glass substrate of any one of Aspects (25) through (46), wherein the first portion and the third portion comprise a convex curvature

Aspect (48) of this disclosure pertains to the cold-formed cover glass substrate of any one of Aspects (25) through (46), wherein the first portion and the third portion comprise a concave curvature.

Aspect (49) of this disclosure pertains to the cold-formed cover glass substrate of any one of Aspects (25) through (48), further comprising a display, touch panel or a combination thereof disposed adjacent one or both of the first major surface or the second major surface.

Aspect (50) of this disclosure pertains to the cold-formed cover glass substrate of any one of Aspects (25) through (49), further comprising a sensor disposed adjacent one or both of the first major surface or the second major surface.

Aspect (51) of this disclosure pertains to the cold-formed cover glass substrate of any one of Aspects (25) through (50), wherein the third portion comprises a second glass substrate attached to one or both of the first and second major surfaces.

Aspect (52) of this disclosure pertains to the cold-formed cover glass substrate of any one of Aspects (25) through (51), wherein, when an impactor having a mass of 6.8 kg impacts the first major surface at an impact velocity of 5.35 m/s to 6.69 m/s, the deceleration of the impactor is 120 g (g-force) or less.

Aspect (53) of this disclosure pertains to the cold-formed cover glass substrate of Aspect (52), wherein the deceleration of the impactor is not greater than 80 g for any 3 ms interval over a time of impact.

Aspect (54) of this disclosure pertains to an automotive interior system comprising: a base; and a cold-formed cover glass substrate according to any one of Aspects (1) through (24) disposed on the base, and wherein, when an impactor having a mass of 6.8 kg impacts the first major surface at an impact velocity of 5.35 m/s to 6.69 m/s, the deceleration of the impactor is 120 g (g-force) or less.

Aspect (55) of this disclosure pertains to the automotive interior system of Aspect (54), wherein the deceleration of the impactor is not greater than 80 g for any 3 millisecond (ms) interval over a time of impact.

Aspect (56) of this disclosure pertains to the automotive interior system of Aspect (54) or Aspect (55), wherein the base is curved.

Aspect (57) of this disclosure pertains to the automotive interior system of Aspect (54) or Aspect (55), wherein the base is flat.

Aspect (58) of this disclosure pertains to the automotive interior system of any one of Aspects (54) through (57), wherein the base comprises a dashboard, an arm rest, a pillar, a seat back, a floor board, a headrest, or a door panel.

Aspect (59) of this disclosure pertains to the automotive interior system of any one of Aspects (54) through (58), wherein the system comprises an infotainment system.

Aspect (60) of this disclosure pertains to an automotive interior system comprising: a base; and a cold-formed cover glass substrate according to any one of claims 25-53 disposed on the base, and wherein, when an impactor having a mass of 6.8 kg impacts the first major surface at an impact velocity of 5.35 m/s to 6.69 m/s, the deceleration of the impactor is 120 g (g-force) or less.

Aspect (61) of this disclosure pertains to the automotive interior system of Aspect (60), wherein the deceleration of the impactor is not greater than 80 g for any 3 millisecond (ms) interval over a time of impact.

Aspect (62) of this disclosure pertains to the automotive interior system of Aspect (60) or Aspect (61), wherein the base is curved.

Aspect (63) of this disclosure pertains to the automotive interior system of Aspect (60) or Aspect (61), wherein the base is flat.

Aspect (64) of this disclosure pertains to the automotive interior system of any one of Aspects (60) through (63), wherein the base comprises a dashboard, an arm rest, a pillar, a seat back, a floor board, a headrest, or a door panel.

Aspect (65) of this disclosure pertains to the automotive interior system of any one of Aspects (60) through (64), wherein the system comprises an infotainment system.

It will be apparent to those skilled in the art that various modifications and variations can be made without departing from the spirit or scope of the invention.

What is claimed is:

1. A cold-formed cover glass substrate comprising:
a first end;
a second end opposing the second end;
a first major surface extending from the first end to the second end, a second major surface opposing the first major surface, a minor surface connecting the first major surface and the second major surface, a thickness defined as a distance between the first major surface and the second major surface, a width defined as a first dimension of one of the first or second major surfaces orthogonal to the thickness, a length defined as a second dimension of one of the first or second major surfaces orthogonal to both the thickness and the width;
a first axis and a second axis, the first and second axis both extending along the width or the length;
a first portion extending from the first axis to the first end, the first portion comprising a first radius of curvature in a range from about 20 mm to about 20,000 mm; and
a second portion extending from the first axis to the second axis, the second portion comprising a second radius of curvature that increases or decreases from the first axis to the second axis.

2. The cold-formed cover glass substrate of claim 1, wherein the first axis and the second axis are disposed between the first end and the second end.

3. The cold-formed cover glass substrate of claim 1, wherein the first axis is disposed between the first and second ends, and the second axis is disposed at the second end.

4. The cold-formed cover glass substrate of claim 1, wherein the distance between the first axis and the second axis is about 100 micrometers (μm) or less.

5. The cold-formed cover glass substrate of claim 1, wherein the distance between the first axis and the second axis is about 10 micrometers (μm) or less.

6. (canceled)

7. The cold-formed cover glass substrate of claim 1, wherein the second radius of curvature is in a range from the first radius of curvature to about 30,000 mm.

8. The cold-formed cover glass substrate of claim 1, wherein one or both of the first portion and the second portion comprises a substrate Gaussian curvature, wherein the substrate Gaussian curvature has an absolute value in a range from greater than zero to about 3×10⁻⁶.

9. (canceled)

10. (canceled)

11. (canceled)

12. (canceled)

13. (canceled)

14. The cold-formed cover glass substrate of claim 1, further comprising a third portion disposed between the second end and the second axis, wherein the third portion comprises a third radius of curvature that differs from the first radius of curvature.

15. The cold-formed cover glass substrate of claim 14, wherein one of the first portion and the third portion comprises a concave curvature and the other one of the first portion and the third portion comprises a convex curvature.

16. (canceled)

17. The cold-formed cover glass substrate of claim 14, wherein the first portion and the third portion both comprise a convex curvature or a concave curvature.

18. (canceled)

19. (canceled)

20. (canceled)

21. (canceled)

22. (canceled)

23. The cold-formed cover glass substrate of claim 1, wherein, when an impactor having a mass of 6.8 kg impacts the first major surface at an impact velocity of 5.35 m/s to 6.69 m/s, the deceleration of the impactor is 120 g (g-force) or less, wherein the deceleration of the impactor is not greater than 80 g for any 3 ms interval over a time of impact.

24. (canceled)

25. A cold-formed cover glass substrate comprising:
a first end;
a second end opposing the first end;
a first major surface extending the first end to the second end, a second major surface opposing the first major surface, a minor surface connecting the first major surface and the second major surface, a thickness defined as a distance between the first major surface and the second major surface, a width defined as a first dimension of one of the first or second major surfaces orthogonal to the thickness, a length defined as a second dimension of one of the first or second major surfaces orthogonal to both the thickness and the width;
a first axis and a second axis, the first axis and the second axis both extending along the width or the length;
a first portion extending from the first axis to the first end, the first portion comprising a first radius of curvature in a range from about 20 mm to about 20,000 mm;
a second portion extending from the first axis to the second axis; and
a third portion extending from the second axis to the second end,
wherein the third portion comprises a third radius of curvature in a range from about 20 mm to about 20,000 mm, and
wherein the first portion and the third portion differ from one another,
wherein the cold-formed cover glass substrate comprises one or more of:
the first radius of curvature and the third radius of curvature differ from one another in magnitude,
the first portion, the second portion or the third portion comprises a non-zero substrate Gaussian curvature, and
the first portion comprises a concave shape or a convex shape and the third portion comprises the other of a concave shape or a convex shape.

26. (canceled)

27. The cold-formed cover glass substrate or claim 25, wherein the substrate Gaussian curvature is an absolute value in a range from greater than zero to about 3×10⁻⁶.

28. The cold-formed cover glass substrate or claim 27, further comprising a support structure comprising a support surface that is attached to the first major surface of the first portion, the second portion or the third portion and forms an interface,
wherein along the interface, the first major surface comprises the substrate Gaussian curvature and the support surface comprises a support Gaussian curvature that is within 10% of the substrate Gaussian curvature.

29. The cold-formed cover glass substrate of claim 25, wherein the second portion is curved, and comprises the substrate Gaussian curvature.

30. The cold-formed cover glass substrate of claim 25, wherein the first portion and the third portion are oriented along two bend axes that differ from one another.

31. (canceled)

32. (canceled)

33. The cold-formed cover glass substrate of claim 25, wherein the second portion is curved and comprises a second radius of curvature that increases or decreases from the first axis to the second axis.

34. (canceled)

35. (canceled)

36. The cold-formed cover glass substrate of claim 25, wherein the distance between the first axis and the second axis is about 100 micrometers (μm) or less.

37. The cold-formed cover glass substrate of claim 36, wherein the distance between the first axis and the second axis is about 10 micrometers (μm) or less.

38-65. (canceled)
